(19) United States
(12) Patent Application Publication
(10) Pub. No.: US 2007/0180479 A1
(43) Pub. Date: Aug. 2, 2007

(54) INTERACTIVE VIDEO ON DEMAND (IVOD)

(75) Inventors: Craig S. Gravina, Farmington, CT (US); John P. Kavanagh, Palo Alto, CA (US)

Correspondence Address: TILLMAN WRIGHT, PLLC, P.O. BOX 471581, CHARLOTTE, NC, 28247, US

(73) Assignee: BRIGHT ENTERTAINMENT LIMITED, London (GB)

(21) Appl. No.: 11/620,636

(22) Filed: Jan. 5, 2007

Related U.S. Application Data
(63) Continuation-in-part of application No. 10/904,039, filed on Oct. 20, 2004.
(60) Provisional application No. 60/766,251, filed on Jan. 5, 2006.

(51) Int. Cl. H04N 7/173; H04N 7/16; H04N 5/445; G06F 3/00; G06F 13/00

(52) U.S. Cl. 725/87; 725/86; 725/61; 725/100; 725/131; 725/139

(57) ABSTRACT

A method performed by a user control device for providing an interactive experience with video on demand (VOD) media content includes receiving a user-generated signal that is representative of a response of the user to a first video sequence of the VOD media content that is presented to the user; determining one or more media control signals to communicate to a multimedia control device that will result in the playing of an appropriate video sequence of the VOD media content in order to provide the user an interactive experience with the VOD media content; and wirelessly communicating the one or more media control signals for playing of the appropriate video sequence. The appropriate video sequence of the VOD media content is played in reply to the response of the user, and the interactive experience with the VOD media content is provided to the user.

### CROSS-REFERENCE AND INCORPORATION OF RELATED APPLICATIONS

The present application is a U.S. continuation-in-part patent application of, and claims priority under 35 U.S.C. § 120 to, U.S. nonprovisional patent application Ser. No. 10/904,039, filed Oct. 20, 2004, which nonprovisional patent application is incorporated by reference herein, and which published on Mar. 17, 2005, as U.S. Patent Application Publication No. 2005/0060238, which also is incorporated herein by reference. The present application is a U.S. nonprovisional patent application of, and claims priority under 35 U.S.C. § 119(e) to, U.S. provisional patent application Ser. No. 60/766,251, filed Jan. 5, 2006, which provisional patent application is incorporated by reference herein.

### COPYRIGHT STATEMENT

All of the material in this patent document is subject to copyright protection under the copyright laws of the United States and of other countries. The copyright owner has no objection to the facsimile reproduction by anyone of the patent document or the patent disclosure, as it appears in governmental records, but otherwise reserves all copyright rights whatsoever.

### SUMMARY OF THE INVENTION

The present invention has many aspects and features. In a first aspect, a method performed by a user control device for providing an interactive experience with video on demand (VOD) media content comprises multiple steps. Step (a) includes receiving, by the user control device, a user-generated signal that is representative of a response of the user to a first video sequence of the VOD media content that is presented to the user. Step (b) includes determining, by the user control device, one or more media control signals to communicate to a multimedia control device that will result in the playing of an appropriate video sequence of the VOD media content in order to provide to the user an interactive experience with the VOD media content. The appropriate video sequence is one of a plurality of possible video sequences of the VOD media content that are available for presentation to the user subsequent to the first video sequence. The determining in step (b) is in response to the user-generated signal received in step (a). Step (c) includes wirelessly communicating, by the user control device, for receipt by the multimedia control device, the one or more media control signals determined in step (b) for playing of the appropriate video sequence. The appropriate video sequence of the VOD media content is played in reply to the response of the user in step (a), and the interactive experience with the VOD media content is provided to the user.

In a feature of this aspect, the media control device comprises a digital cable set-top box. In another feature, the user control device comprises a remote control. With regard to this feature, the remote control includes software (i.e., data and/or computer-executable instructions) specific to the video sequences of the VOD media content. The software constitutes the logic for navigating the video sequences so as to provide an interactive experience. With further regard to this feature, the software comprises a script. The remote control includes a processor and script interpreter for executing the script. It is preferred that the scripting language is an XML language. In accordance with this feature, the software is provided to the remote control via a removable memory device. It is preferred that the removable memory device comprises a cartridge. It is also preferred that the removable memory device constitutes part of a user interface component that is removably attached to a base of the remote control. In further accordance with this feature, the software is provided wirelessly to the remote control.

In an additional feature, the user control device comprises a user interface component and a remote control base to which the user interface component is removably coupled. In accordance with this feature, the user interface component may comprise an overlay, a card, an insert, a book, or a touch screen and a graphical user interface (GUI). With regard to the GUI, a removable memory device includes software (i.e., data and/or computer-executable instructions) specific to the video sequences of the VOD media content. The software constitutes the logic for navigating the video sequences so as to provide an interactive experience, and further includes software defining the GUI. It is preferred that the GUI is specific to the video sequences of the VOD media content.

In yet other features, the user control device comprises a book, a child's toy, a doll, and a child's activity table. In a further feature, step (c) comprises transmitting infrared (Ir) wireless communications. In another feature, step (c) comprises transmitting radio frequency (RF) wireless communications.

In an additional feature, a user control device performs the method as described above. In a further feature, a VOD system is configured to perform the method as described above.

In a second aspect of the invention, a method of interactively viewing, by a child, video on demand (VOD) media content comprises multiple steps. Step (a) includes storing, at a head-end of a VOD system, VOD media content. The VOD media content is organized into at least two child-oriented programs, with each program configured to display, on a television, both video content for viewing by a child and menus of selection options for navigating of the program by the child. Each menu of the program has at least some selection options displayed using child-recognizable icons. Step (b) includes selecting a user interface component from a plurality of user interface components. Each user interface component is specific to a respective one of the child-oriented programs stored at the VOD head-end, and each user interface component includes a plurality of child-recognizable icons that are depicted thereon and that correspond visually to icons displayed in the menus of the respective program. Step (c) includes coupling the user interface component to a remote control component having a control chip configured to send wireless control signals, representative of industry standard set-top remote control button presses, to a set-top box for controlling presentation of the VOD media content. Step (d) includes viewing, by the child, the video content of the respective child-oriented program and a menu of selection options of the respective program as displayed using the child-recognizable icons. Step (e) includes choosing, by the child, one of the selection options from the menu of selection options viewed by the child and displayed on the television using the child-recognizable icons. Step (f) includes identifying, by the child, the icon on the coupled user interface component that visually corresponds to the icon, on the menu of selection options, that represents the chosen selection option. Step (g) includes pressing, by the child, the identified icon of the user interface component to cause the remote control component to send one or more wireless remote control signals, representative of an industry standard set-top remote control button press, to the set-top box indicating to the set-top box the selection option chosen by the child from the viewed menu of displayed selection options.

In a feature of this aspect, the set-top box includes software (i.e., data and/or computer-executable instructions) specific to the video sequences of the VOD media content. The software constitutes the logic for navigating the video sequences so as to provide an interactive experience. With regard to this feature, the software is provided to the set-top box via a removable memory card. In addition, the software comprises a scripting language and is independent of the brand and model of the set-top box and is independent of the VOD system. Further, the software is downloaded to the set-top box. Still further, the software is downloaded to the set-top box upon selection of one of the two child-oriented programs. With regard to this feature, the software that is downloaded to the set-top box upon selection of a first of the two child-oriented programs is different from the software that is downloaded to the set-top box upon selection of the other of the two child-oriented programs.

In a third aspect of the invention, a method of interactively viewing, by a child, video on demand (VOD) media content comprises multiple steps. Step (a)includes storing, at a head-end of a VOD system, VOD media content. The VOD media content is organized into at least two child-oriented programs, with each program configured to display, on a television, both video content for viewing by a child and menus of selection options for navigating of the program by the child. Each menu of the program has at least some selection options displayed using child-recognizable icons. Step (b) includes displaying, on a user control device, a graphical user interface from a plurality of graphical user interfaces to the child. Each graphical user interface is specific to a respective one of the child-oriented programs stored at the VOD head-end, and each graphical user interface includes a plurality of child-recognizable icons that are depicted thereon and that correspond visually to icons displayed in the menus of the respective program. The user control device has a control chip configured to send wireless control signals, representative of industry standard set-top remote control button presses, to a set-top box for controlling presentation of the VOD media content. Step (c) includes viewing, by the child, the video content of the respective child-oriented program and a menu of selection options of the respective program as displayed using the child-recognizable icons. Step (d) includes choosing, by the child, one of the selection options from the menu of selection options viewed by the child and displayed on the television using the child-recognizable icons. Step (e) includes identifying, by the child, the icon on the displayed graphical user interface that visually corresponds to the icon, on the menu of selection options, that represents the chosen selection option. Step (f) includes pressing, by the child, the identified icon of the graphical user interface to cause the user control device to send one or more wireless remote control signals, representative of an industry standard set-top remote control button press, to the set-top box indicating to the set-top box the selection option chosen by the child from the viewed menu of displayed selection options.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram of an interactive video on demand system in accordance with preferred embodiments of the present invention;

FIG. 2 is a block diagram of the VOD head-end system of FIG. 1;

FIG. 3 is a block diagram of the distribution network of FIG. 1;

FIG. 4 is a block diagram of one of the set-top devices of FIG. 1;

FIG. 5 is a high-level block diagram of one of the user control devices of FIG. 1;

FIG. 6 is a top perspective view of a first exemplary implementation of the user control device of FIG. 5;

FIG. 7 is a top perspective view of a second exemplary implementation of the user control device of FIG. 5;

FIGS. 8A-8C are top perspective views of variations of the user interface component of FIG. 7;

FIG. 9 is a perspective view of a particular implementation of the user control device of FIG. 7;

FIG. 10 is a top view of the user interface component of a third exemplary implementation of the user control device of FIG. 5;

FIG. 11 is a top plan view of the user interface component of FIG. 6;

FIG. 12 is a top view of the remote control base unit of FIG. 6, showing a simplified circuit diagram;

FIG. 13 is a top plan view of a variation of the user interface component of FIGS. 6 and 11;

FIG. 14 is a top plan view of the user interface component of FIG. 5 showing a simplified circuit diagram for an alternative arrangement of switches;

FIG. 15 is a top plan view of the remote control base unit of FIG. 5 showing a simplified circuit diagram for the alternative arrangement of switches of FIG. 14;

FIG. 16 is a top plan view of the implementation of the user interface component of FIG. 11 with a memory added thereto;

FIG. 17 is a top plan view of the implementations of the remote control base unit of FIG. 12 with electrical connections to the memory of FIG. 16 added thereto;

FIG. 18 is a top plan view of the implementation of the user interface component of FIG. 14 with a memory added thereto;

FIG. 19 is a top plan view of the implementations of the remote control base unit of FIG. 15 with electrical connections to the memory added thereto;

FIG. 20 is an exemplary script for an input comprising a button;

FIG. 21 is an exemplary script illustrating a group of commands that are to be issued when a button identified as the “Monkey” button is pressed;

FIG. 22 is an exemplary script illustrating a collection of media device independent commands for controlling media presentation;

FIG. 23 is an exemplary script illustrating an example of a conditional statement in a script;

FIG. 24 is a more complete exemplary script illustrating several of the aforementioned concepts;

FIG. 25 is a schematic diagram of a user control device for which the script of FIG. 24 is designed; and

FIGS. 26-34 illustrate additional implementations and preferred embodiments of the invention.

### DETAILED DESCRIPTION OF PREFERRED EMBODIMENTS

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, preferred embodiments of the present invention are next described. The following description of preferred embodiment(s) is merely exemplary in nature and is in no way intended to limit the invention, its application, or uses.

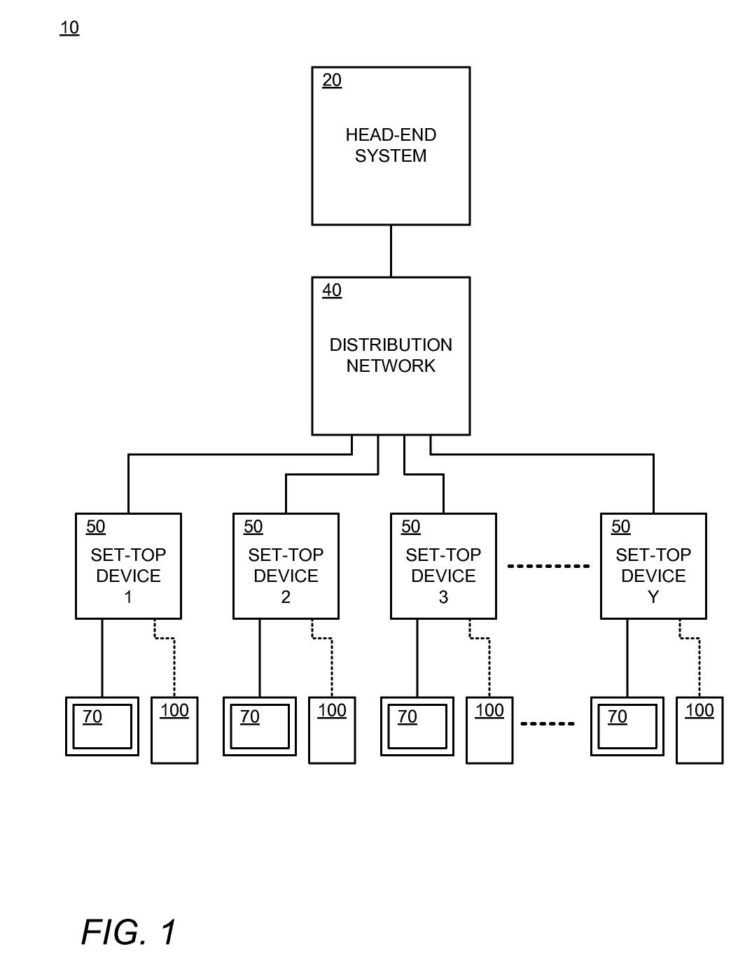

FIG. 1 is a block diagram of an interactive video on demand system 10 in accordance with preferred embodiments of the present invention. As shown therein, the system 10 generally includes a video on demand (“VOD”) head-end system 20, one or more set-top devices 50 connected to the head-end system 20 by a distribution network 40, one or more audio/video systems 70, and one or more user control devices 100. In summary, each user control device 100 permits a user to retrieve multimedia content from the VOD head-end system 20 via one of the set-top devices 50 for presentation to the user on one of the audio/video systems 70. Each of these components is described in greater detail hereinbelow.

In the following description, it has generally been assumed that there are a plurality of set-top devices 50 in the VOD system 10 and that each set-top device 50 has exactly one audio/video system 70 and one user control device 100 associated therewith. However, it will be appreciated that preferred embodiments of the present invention may be implemented in a wide variety of ways. For example, in some implementations, a VOD head-end system 20 may service only one set-top device 50; in other implementations, each set-top device 50 may access a plurality of VOD head-end systems 20; in other implementations, a single set-top device 50 may be associated with a plurality of audio/video systems 70; in other implementations, a single set-top device 50 may be associated with a plurality of user control devices 100; in other implementations, a single user control device 100 may be associated with a plurality of audio/video systems 70. Furthermore, it will be appreciated that other permutations of the various components of the system 10 may likewise be implemented.

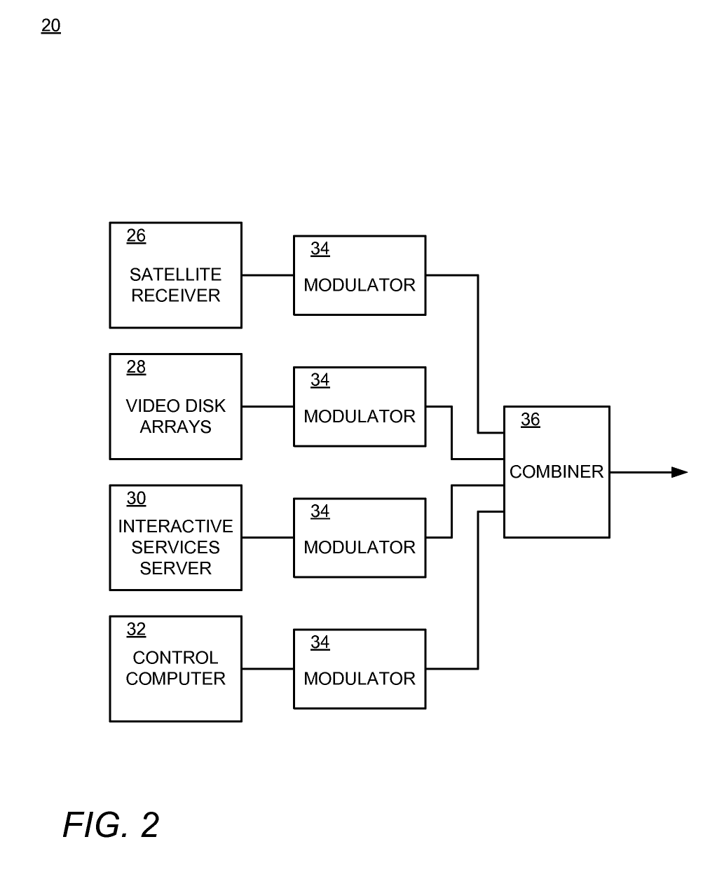

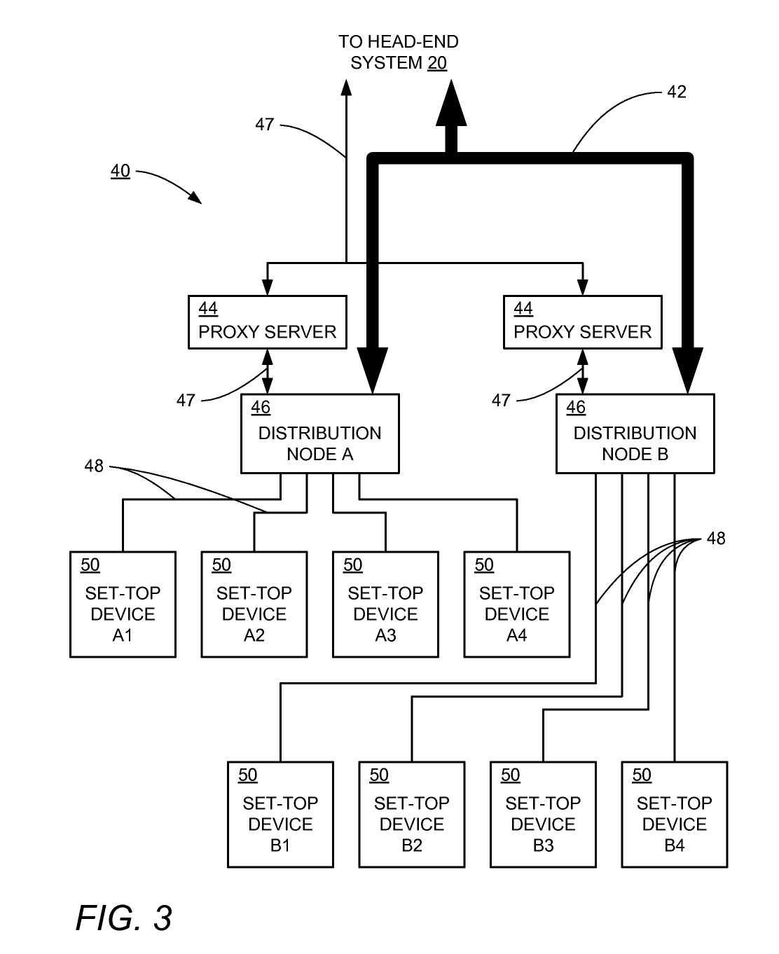

FIG. 2 is a block diagram of the VOD head-end system 20 of FIG. 1. The head-end system 20 includes the components typically associated with a cable television head-end installation, e.g. satellite receivers 26 for receiving satellite broadcasts and producing corresponding baseband analog video signals. Additionally, the head-end system 20 includes fast digital disk arrays and/or optical storage 28 for storage of MPEG-encoded digital video for on-demand delivery. The head-end system 20 also includes one or more interactive services servers 30, which output menuing and other user interface materials for use by the set-top devices 50 in the system 10 for providing interactivity with users. Particularly in systems 10 not employing proxy servers 44 (perhaps best shown in FIG. 3), described below, the head-end system 20 may additionally include a control computer 32 that receives and transmits control data relating to system administration (e.g., channel assignment data, billing information, and the like).

The transmission of these various forms of data from the head-end system 20 over the network 40 is straightforward. As is familiar to the Ordinary Artisan, the analog video is commonly distributed on 6 MHz channels, beginning at 52 MHz and extending upwardly. The digital video can be encoded on a carrier for transmission within one of these conventional broadcast channels, or can be modulated at one or more other unused frequencies by modulators 34. Statistical multiplexing is desirably employed to transmit plural channels of digitized video with reduced bandwidth. The interactive services and the control data can be transmitted using a conventional protocol, such as TCP/IP, and modulated via additional modulators 34 onto a suitable carrier frequency for distribution over the network 40. Alternatively, such data can be transmitted in the vertical blanking interval of analog video broadcasts, as is well known. After modulation, the various signals from the head-end system 20 are combined by an RF combiner 36 for distribution over the network 40.

FIG. 3 is a block diagram of the distribution network 40 of FIG. 1. The distribution network 40 typically comprises coaxial cable or optical fiber 42 extending from the head-end system 20 to distribution nodes 46 within various neighborhoods or buildings. From the distribution nodes 46, further cables 48 couple to individual subscriber's premises, which may be single-family houses, apartments or units of multi-unit dwellings, rooms or suites in a hotel or similar structure, or the like. Optionally, the network 40 can include one or more proxy servers 44, which are computers interposed between the head-end system 20 and the set-top devices 50 to perform various system control and user interface (“UI”) functions. If utilized, the proxy server 44 is interposed in a logical TCP/IP control channel 47 between the head-end system 20 and the set-top devices 50. It should be noted that while the control signals and the media content are generally physically conveyed on the same cable, they are shown separately in FIG. 3 for clarity.

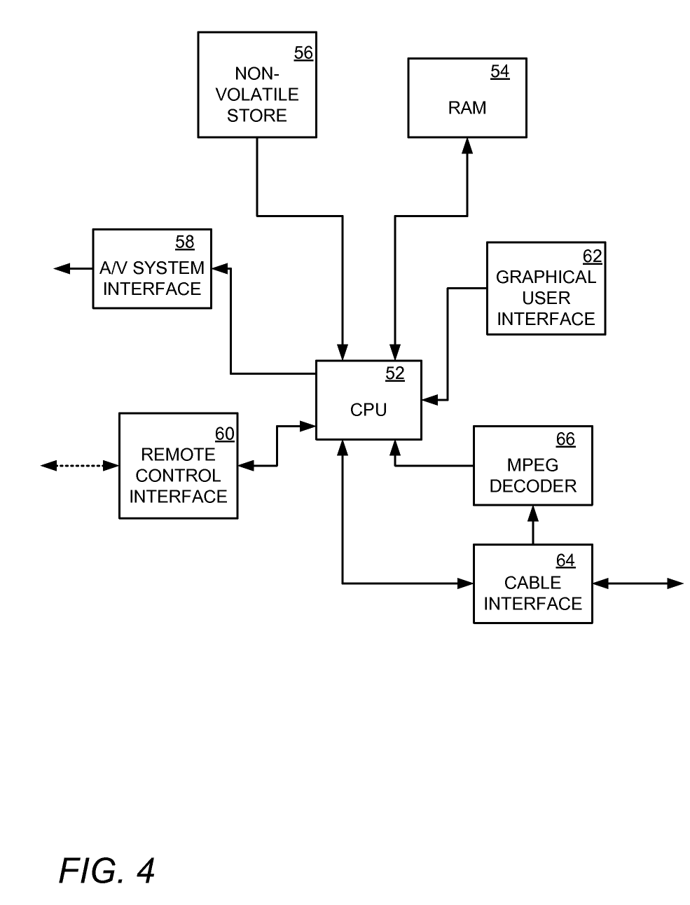

FIG. 4 is a block diagram of one of the set-top devices 50 of FIG. 1. Each set-top device 50 includes a CPU 52, RAM memory 54, non-volatile memory 56, an audio/video system interface 58, a remote control interface 60, a software-based graphical user interface (“GUI”) 62, a cable interface 64 and an MPEG decoder 66. The CPU 52 may be any of several microprocessors, suitable examples of which are commonly available from Intel, Motorola, and other companies. Alternatively, the CPU 52 can be a custom device, such as an ASIC, in which one or more of the other components of the set-top device 50 are integrated. The RAM memory 54 preferably includes at least 16K of memory, but greater or lesser amounts of memory, and of differing types, may alternatively be used. The non-volatile memory 56 preferably includes a ROM, EEPROM, or flash memory in which certain components of the operating system and applications software are stored. Additionally, the non-volatile memory 56 preferably includes 4 GB or more of magnetic disk storage.

The audio/video system interface 58 and the remote control interface 60 may each be conventional in nature. The audio/video system interface may include appropriate driver circuitry, such as amplifiers, filters and the like, and appropriate output connections, such as RCA plugs, for conventional cables connecting the set-top device 50 to the audio/video system 70. The remote control interface 60 may include an IR transmitter/receiver and accompanying circuitry to permit communication with the user control device 100 via standard IR communication signals. Alternatively, the remote control interface 60 may include an RF transmitter/receiver and accompanying circuitry, a direct wired interface, or any other suitable communications interface for sending signals from the user control device 100, providing that the user control device 100 utilizes a corresponding communications interface. Moreover, in accordance with preferred embodiments of the invention, the remote control interface itself may send communications to the user control device 100. For example, the script for particular VOD media content may be downloaded to the set-top box and then communicated to the user control device 100 via the remote control interface 60.

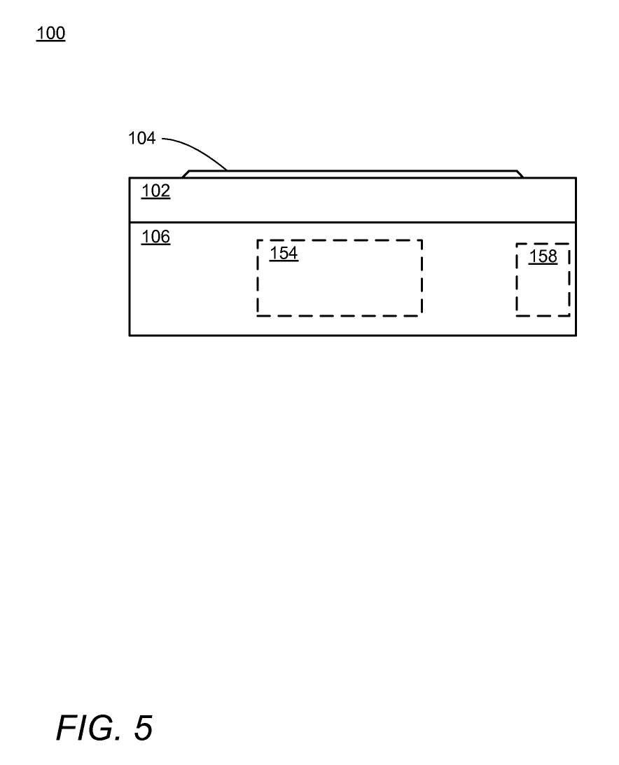

The GUI 62 in the illustrated embodiment refers to various on-screen visual displays through which the user can effect various choices using one of the user control devices 100 (perhaps best shown in FIG. 5). For example, the user may use a user control device 100 to switch channels or choose a different media program, and furthermore to interact with the program in a variety of ways. Although illustrated separately for clarity, the Ordinary Artisan will understand that the GUI 62 is typically realized as instructions stored in the RAM memory 54.

The cable interface 64 receives composite data signals from the network 40 and separates them into three general signal types: analog video (typically corresponding to broadcast television programming), digital video (typically corresponding to on-demand video programming) and HTML/control instructions (the former typically corresponding to interactive services, the latter being instructions exchanged between the user control device 100 and the head-end system 20, a proxy server 44 or a neighborhood node 46). Included in the cable interface 64 is an RF tuner section controlled by the CPU 52. The illustrated MPEG decoder 66 is an application-specific integrated circuit that converts the MPEG video stream into successive frames of video data.

In general operation, use of the VOD aspects of the system 10 of the present invention is similar to conventional VOD systems. To view an on-demand video program, a user first tunes the set-top device 50 to a predetermined viewer channel, typically identified as a “VIDEO” or “VOD” channel. It will be appreciated, of course, that “viewer channels,” including channels for well-known media networks such as NBC, CNN, and the like, as well as special-function channels such as “chat” channels, “game” channels, “hotel information” channels, and the like, are distinguished from “transmission channels,” which refer to the frequency channels over which the video signals are distributed from the head-end system 20 through the distribution network 40 to the set-top devices 50. Thus, a user selects a viewer channel, identifying and corresponding to the media content he wishes to view, using the set-top device 50, and a video signal representing the media content itself is transmitted from the head-end system 20 to the set-top device 50 via a particular transmission channel (frequency band) that is selected by some combination of the head-end system 20, a proxy server 44, the set-top device 50, or another component of the system 10.

On the VOD viewer channel, the user is preferably presented with an introductory graphical user interface (GUI) screen. The introductory screen may include several elements, such as a listing of newly released media programs, a listing of most-popular programs, a listing of program categories, a search interface for searching a database of all or a subset of available media programs, a multimedia presentation promoting a particular program or service, other advertising, or any of a wide variety of other elements. Depending on the breadth and scope of the various elements, the various listings or other elements may be organized into menus or submenus. Using one of the user control devices 100 of FIG. 1, a separate remote control (not shown), or a user interface physically located on the set-top device 50 itself, the user may manipulate arrow keys, an “Enter” or “Go” key, and/or other keys or buttons to manually navigate through the menus and submenus and to identify and select a feature of interest, either directly or via one of the menus or submenus.

Once a particular media program has been selected using the method described above, the appropriate video signal, corresponding to that program, is transmitted from the head-end system 20 to the set-top device 50 and the program is presented to the user via the audio/video system 70 connected to the set-top device 50. Conventionally, a remote control (not shown) is used to control playback of the media program from the head-end system 20. The menu may include keys, buttons or other inputs corresponding to conventional remote control inputs and functions thereof. For example, a conventional remote control may include dedicated or reconfigurable user inputs for such functions as “PLAY,” “STOP,” “REWIND,” “FAST FORWARD” and “PAUSE,” wherein each such input and function has the generally conventional implementation thereof. Alternatively, the remote control may provide a single user input in order for a user to access a menu-driven set of conventional controls, wherein the user may press such a key or button to access a list of commands, and may further make a selection of one of the above-mentioned functions from a menu presented in response thereto.

Briefly, playback of the media program may be started by pressing the “PLAY” button, or an equivalent thereof, may be used, or in some cases playback may be accomplished automatically through initial activation of the program or upon some other event. If the user wishes to stop playback, the “STOP” button, or an equivalent thereof, may be used, or in some cases playback may be accomplished automatically by powering the set-top device down or upon some other event. Similarly, if the user wishes to pause playback, the “PAUSE” button, or an equivalent thereof, may be used. Upon either a “STOP” or a “PAUSE” command, a corresponding signal may be sent to the head-end system 20 from the set-top device 50, interrupting MPEG delivery. Furthermore, upon a “PAUSE,” or optionally upon a “STOP,” a data record, indicating the point at which the program has been interrupted, may be stored at the set-top device 50, at the head-end system 20 or at a proxy server 44. The information stored in the record may, for example, include an SMPTE code, a disk address, time offset, or the like.

If the stop in playback is brief, the system 10 may maintain the assignment of the particular transmission channel to the particular set-top device 50, despite the interruption in video delivery. However, if the interruption period exceeds a threshold value (for example, ten minutes), the system 10 may return the assigned transmission channel to a pool of unused (available) transmission channels, from which the channel may then be assigned to another user. The user may still resume playback by using the “PLAY” function, but in this situation, the system 10 would first have to assign a new transmission channel, retuning the set-top device 50 and the head-end system's modulator 34 accordingly, before resuming playback from the point of interruption.

Preferably, the system 10 of the present invention provides most or all of the foregoing functionality in a generally similar manner to that described hereinabove. In addition, however, the system 10 of the present invention provides a much greater degree of interactivity with the video or multimedia content, titles, and programs offered through the VOD system. In certain preferred embodiments, the user primarily accesses such interactivity via one of the user control devices 100 of FIG. 1, but there are other elements involved as well. This additional functionality, and the elements of such preferred embodiments of the present invention that facilitate its delivery, are now described in detail.

FIG. 5 is a high-level block diagram of one of the user control devices 100 of FIG. 1. The preferred user control device 100 includes a remote control base unit 106 (generally referred to hereinafter as an “RC base unit) and a selectable user interface component 102 (generally referred to hereinafter as a “UI component”). The selectable UI component 102 preferably includes an array of user inputs 104, while the RC base unit 106, sometimes referred to hereinafter as a controller, includes a processor 154 that responds to the actuation of any of an array of user inputs 104 by causing an emitter 158 to transmit one or more signals to the set-top device 50. A user input 104 may comprise a switch or a button, or even merely an area designated for application of pressure of a user's finger, such as a printed area on a surface of a card, panel, overlay, or insert.

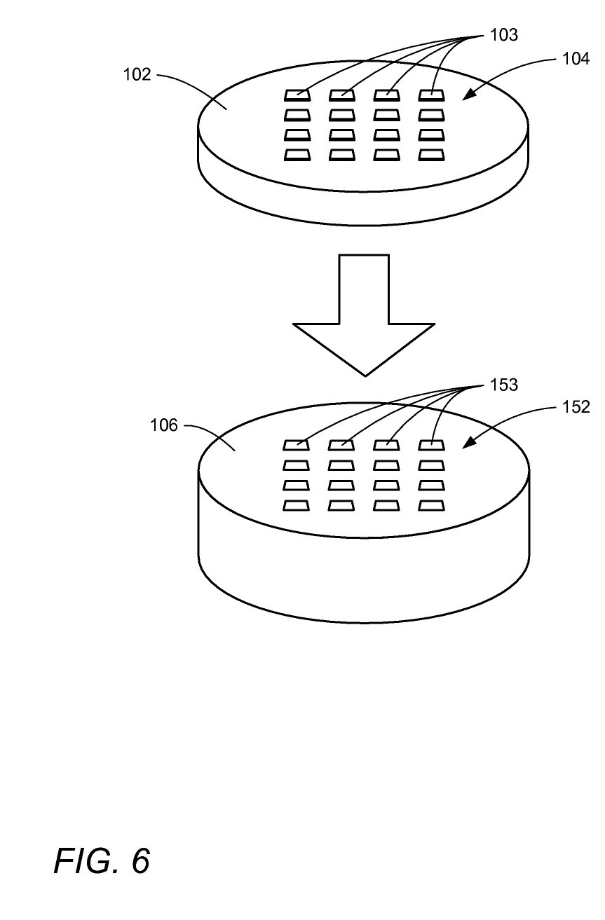

In accordance with one or more aspects of the present invention, the UI component 102 is removably attachable to the RC base unit 106 as illustrated, for example, in FIG. 6. A UI component 102 may interface with an RC base unit 106 in a variety of ways. For example, in FIG. 6, the UI component 102 has a user input array 104 comprising a plurality of rectangular keys or buttons 103 that correspond directly to electrical switches 153 arranged in a matrix 152 in the RC base unit 106. Each button comprises a mechanical component that, when the UI component 102 is coupled to the RC base unit 106, is positioned directly above, and is coupled with, a respective switch 153. Thus, when the UI component 102 is attached to the RC base unit 106, each input 103 is coupled with a switch 153, whereby user actuation of an input 103 results in a signal being generated by the corresponding switch 153.

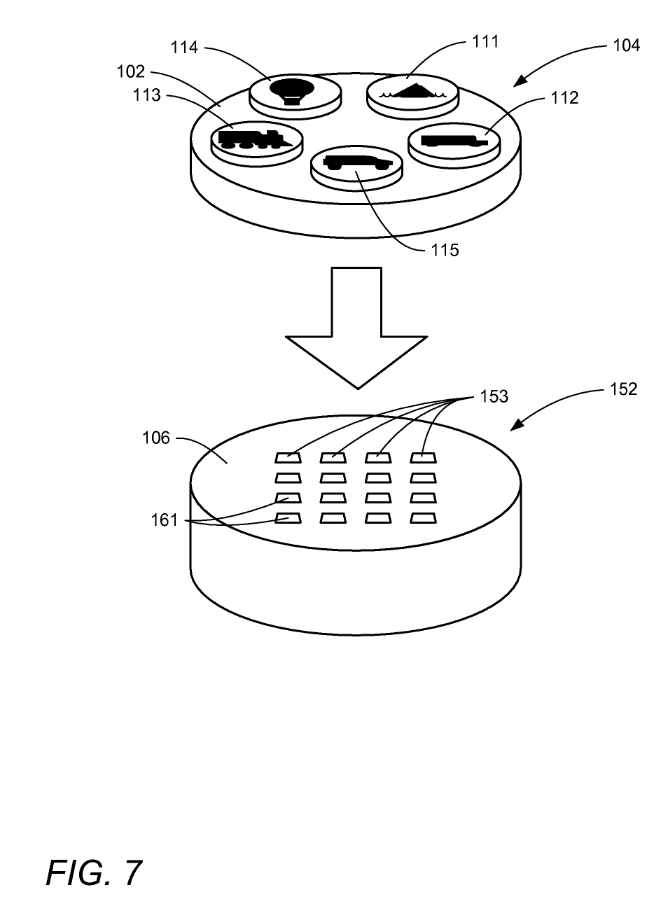

A great number of alternate implementations are available. For example, FIG. 7 illustrates a variation of the arrangement of FIG. 6. Like the implementation of FIG. 6, the UI component 102 in FIG. 7 once again has a user input array 104 comprising a plurality of keys or buttons 111, 112, 113, 114, 115 that correspond to electrical switches 153 in the RC base unit 106. As with the implementation of FIG. 6, each of the particular inputs 111, 112, 113, 114, 115 comprises a mechanical component that, when the respective UI component 102 is coupled to the RC base unit 106, is positioned directly above one or more respective switches 153. However, in the arrangement of FIG. 7, there are fewer user inputs 111, 112, 113, 114, 115 than switches 153, and most or all of the user inputs 111, 112, 113, 114, 115 are positioned above, and coupled to, a plurality of respective switches 153. Thus, for example, actuation of the input 113 bearing indicia of a train results in a signal being generated by each of two switches 161.

With the foregoing as an example, it should be understood that any desired or suitable n to m correlation of any number (n) inputs to any number (m) of controller switches 153 is within the scope of the present invention. Furthermore, though the figures illustrate for convenience spatial alignments of user inputs to correlated controller switches, it should be understood that other alignments or associations facilitated by cantilevers, pads, moving parts, or electrical contacts correlating any one, any number, or any area of inputs 103, 111, 112, 113, 114, 115 to any one, any number, or any area of controller switches 153 are within the scope of the present invention.

As described in detail hereinbelow, the various keys, buttons and other inputs in each user input array 104 may have any of a wide variety of functions. Importantly, each of the UI components 102 shown and described herein, and more particularly, each user input array 104 of each such UI, may, for example, include keys, buttons or other inputs corresponding to conventional remote control inputs and functions thereof. For example, each UI component 102 may include dedicated or reconfigurable user inputs for such functions as “PLAY,” “STOP,” “REWIND,” “FAST FORWARD” and “PAUSE,” wherein each such input and function has the generally conventional implementation thereof. Alternatively, a single user input (likewise not illustrated in any of the UI components 102 shown or described herein) may be provided on any UI component 102 in order for a user to access a menu-driven set of conventional controls, wherein the user may press such a key or button to access a list of commands, and may further make a selection of one of the above-mentioned functions from a menu presented in response thereto. Regardless, for clarity in explaining other aspects of the present invention, however, such inputs have been omitted from the user input arrays 104 shown and described therein. Moreover, it will be apparent that other inputs in the user input array 104 may instead be utilized to carry out these functions, using methods made apparent from the explanations provided hereinbelow.

Returning to the implementation of a UI component 102 shown in of FIG. 7, the pushing of a button 111, 112, 113, 114, 115 (i.e., actuation of a user input) results in the set-top device 50 displaying a particular educational segment via the audio/video system 70. In accordance with the present invention, this segment of media content is initially retrieved from the VOD head-end system 20, where it is stored, and it is made available for viewing “on demand” via the set-top device 50 and audio/video system 70 in conjunction with the user control device 100. Moreover, in such an implementation, each button 111, 112, 113, 114, 115 preferably includes graphical indicia pertaining to the media content that is displayed as a result of pushing that particular button 111, 112, 113, 114, 115. For example, the pushing by hand of the button 113 that includes indicia of a train may result in the display of an educational video segment pertaining to trains. In other words, the components of the UI component 102 may be arranged such that pressing a button 111, 112, 113, 114, 115 lets a child trigger presentation of media content associated with the subject matter that is indicated by the button 111, 112, 113, 114, 115. This type of interaction between a user and the media presentation is most suitable for children within the age groups of one to three, teaching a child basic motor skills and empowering the child, and is preferably used to instruct a child about basic sets of abstract concepts regarding, for example, colors, shapes, letters, numbers, animals, and instruments.

It should also be noted that greater interactivity between the user and the media content may also be accomplished. In this regard, the media content presentation may, for example, include a “question and answer” format, wherein the displayed media content poses a question directly to the user that can be answered by pressing a button in the user input array 104. As an example, a segment of an audio/video program may state, “Click on the animal that eats bananas,” wherein if the child responds by pressing a button (not shown) depicting a monkey, the program provides a positive response, such as “You're right! A monkey eats bananas!” while if the child alternatively responds by pressing a button (not shown) depicting another animal, the program provides a response such as “Sorry; please try again!” Alternatively, the media content presentation may include a “choose your own adventure” format, wherein the media content narrative pauses at key points in a storyline in order for the child to determine the future direction of the story. As an example, a segment of the program may state, “Should you take the road going North or the road going South?” and wherein, if the child responds by pressing a button (not shown) indicating “North,” the story resumes with that response as its basis, while if the child responds by pressing a button (not shown) indicating “South” the story resumes with that alternative response as its basis.

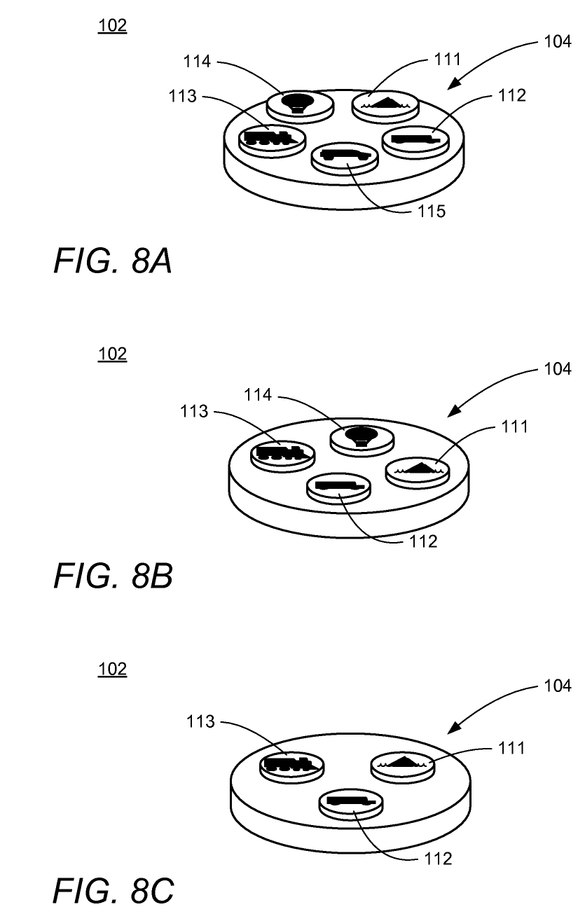

It should also be noted that, as exemplified by the implementations shown in FIGS. 6 and 7, the RC base unit 106 may accept any one of various UI components 102 corresponding to different content programs, segments, and/or titles that may be available from the VOD head-end system 20 or distribution network 40 via the set-top device 50 and audio/video system 70. Thus, for example, with reference to FIGS. 8A-8C, the user at a particular user's premises may be provided with three different UI components 102, each of which may be separately coupled to the RC base unit 106, for three different programs. Typically, each UI component 102 would correspond to a separate one of the programs, and each of the UI components 102 may and probably would include the same number or different number of buttons having different indicia thereon.

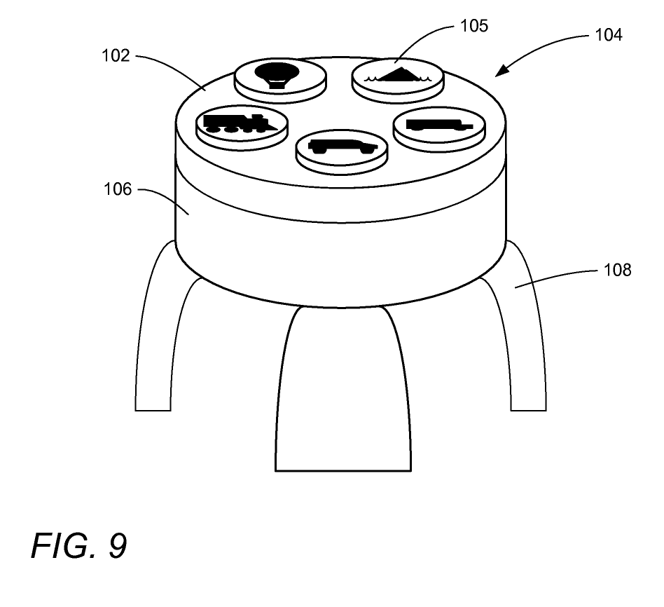

FIG. 9 is a perspective view of a particular implementation of the user control device 100 of FIG. 7. In this implementation, the user control device 100 takes the form of a child's activity table for control of the media content by a child. The activity table is formed by supporting the RC base unit 106 by any suitable number of legs or supports 108 (which may or may not be detachable), and the selectable UI component 102 comprises an overlay. It will likewise be appreciated that the RC base unit 106 can take on any of an wide variety of alternative forms as desired.

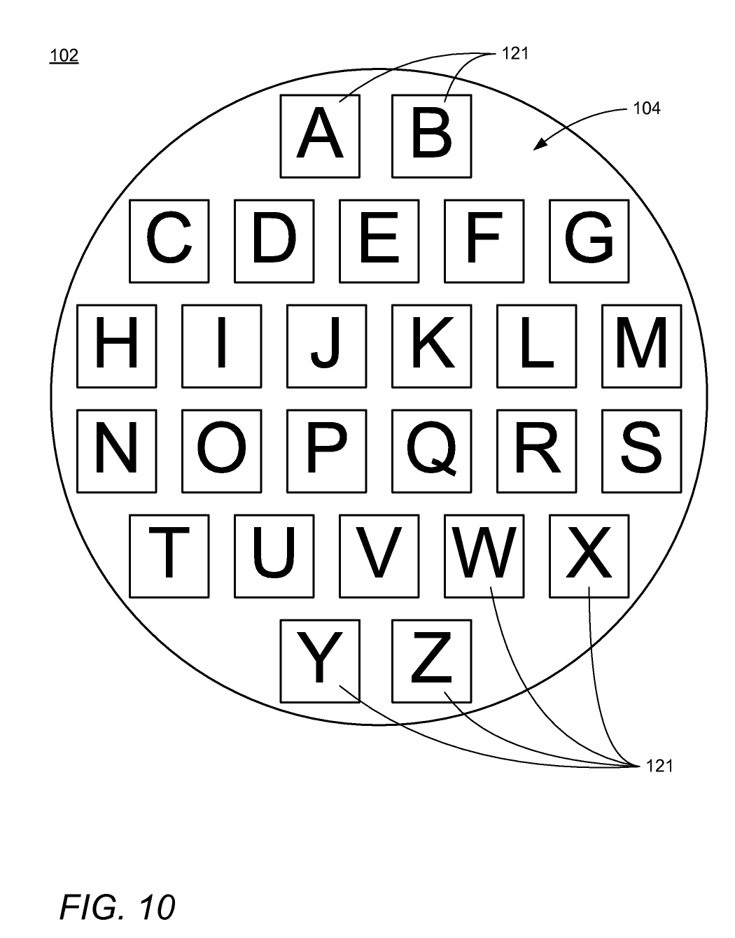

In another implementation, illustrated in FIG. 10, the user input array 104 of the UI component 102 may include twenty-six buttons 121 having the letters of the English alphabet illustrated thereon. The letters may be used in many ways, including for example the selection of songs stored on the VOD head-end system 20 and available via the set-top device 50 and audio/video system 70. In another implementation (not illustrated), the user input array 104 of the UI component 102 may take the form of a map of the United States with buttons shaped and arranged as states. Such an arrangement may be used in many ways, such as in conjunction with an interactive multimedia program having geographic content regarding the United States, wherein the pressing of a state-shaped button would result in presentation of educational information on that state, the information being stored on the VOD head-end system 20 and available via the set-top device 50 and audio/video system 70. In yet another implementation (not illustrated), the user input array 104 of the UI component 102 may include buttons of various geometric shapes, such as a circle, a triangle, a rectangle, and a square. Such an arrangement may be used in many ways, such as in conjunction with an interactive multimedia program wherein the pressing of a geometrically shaped button would result in presentation of educational information on the particular geometric shape of the button, the information being stored on the VOD head-end system 20 and available via the set-top device 50 and audio/video system 70.

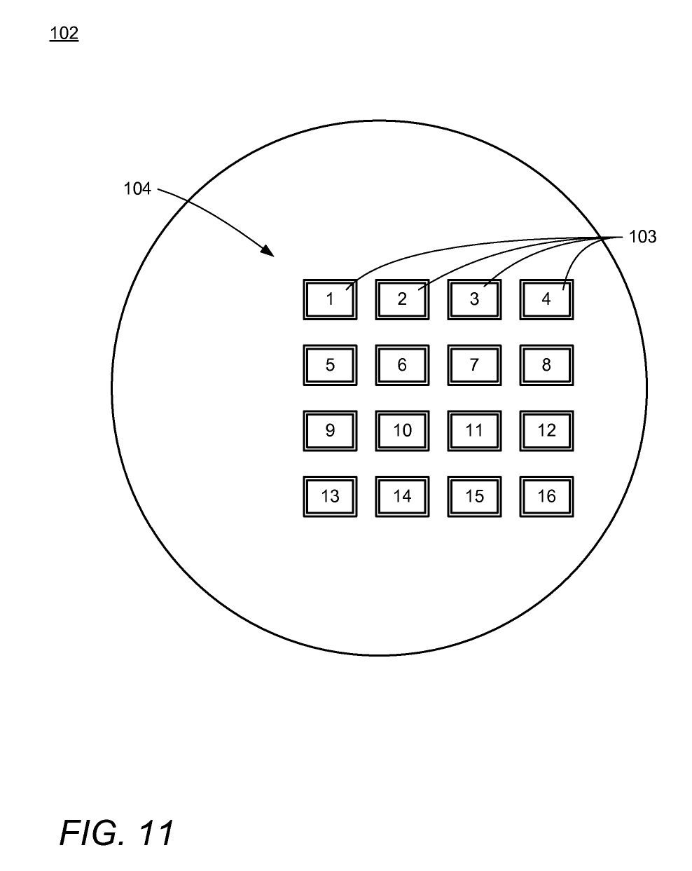

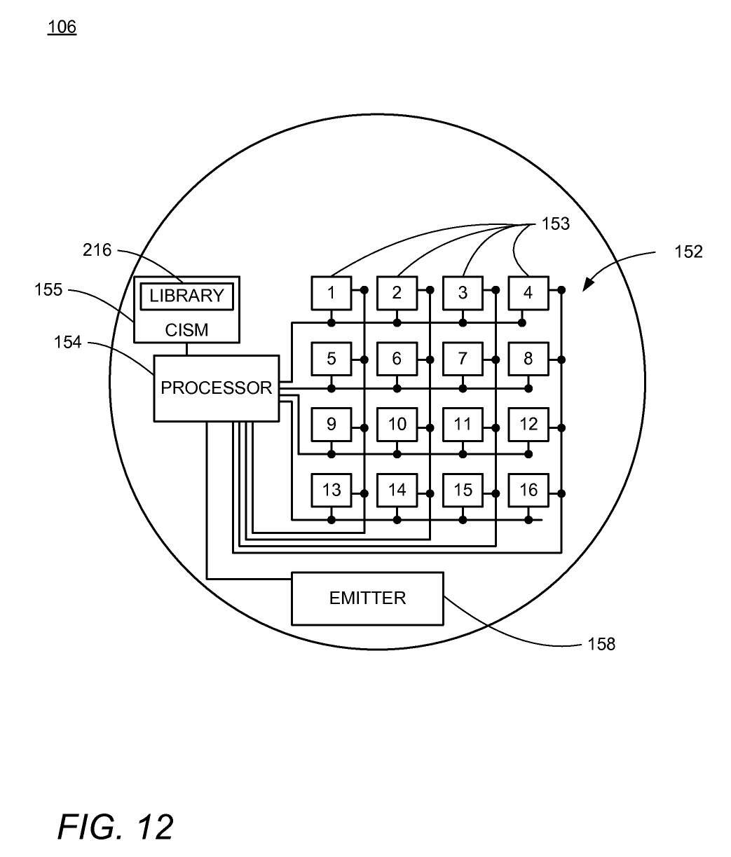

FIG. 11 is a top plan view of the UI component 102 of FIG. 6, and FIG. 12 is a top view of the RC base unit 106 of FIG. 6, showing a simplified circuit diagram. As described previously, the UI component 102 includes a user input array 104, which in this implementation comprise a plurality of rectangular keys or buttons 103, arranged into four columns and four rows. Correspondingly, and as also described the RC base unit 106 includes a matrix 152 of switches 153, which in this implementation are also arranged into four columns and four rows. When the UI component 102 of FIG. 11 is coupled to the RC base unit 106 of FIG. 12, each of the user buttons 103 overlies and aligns with a corresponding switch 153 in the switch matrix 152. Thus, when the two components 102, 106 are coupled, depressing a key 103 actuates a switch 153. In the arrangement shown, the various switches 153 are connected electrically such that two electrical signals are generated whenever a switch 153 is actuated, the two signals being representative of the row and column of the switch 153 in the 4x4 arrangement. In this regard, a power source, such as a battery (not shown), is preferably included in the RC base unit 106 for generating electrical signals from switches 153. The two signals are propagated to the processor 154 and further handled as described hereinbelow.

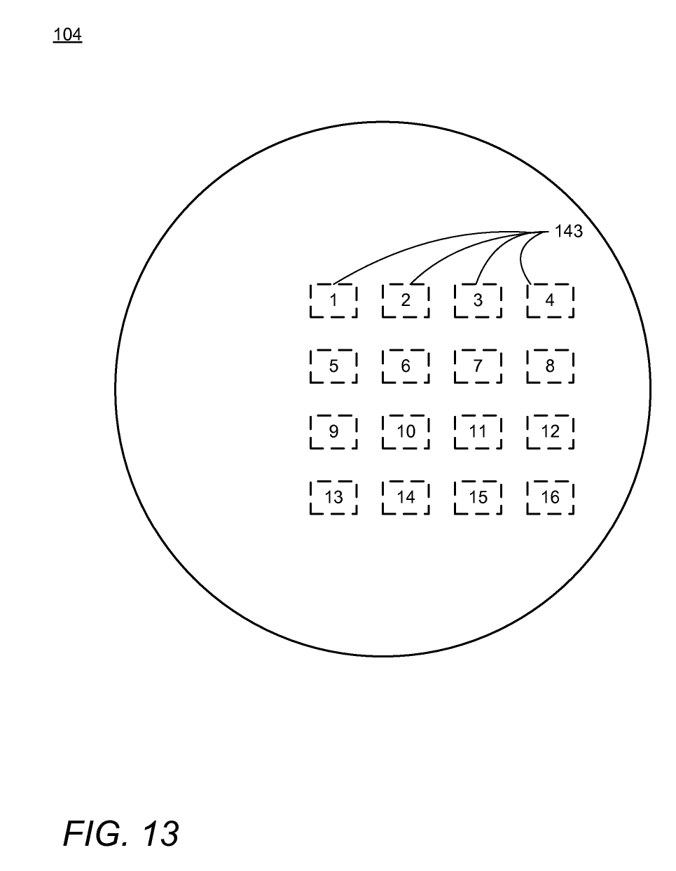

FIG. 13 is a top plan view of a variation of the UI component 102 of FIGS. 6 and 11. In this variation, the UI component 102 is a thin membrane or sheet, wherein the user input array 104 simply comprises designated rectangular areas 143 for guiding the user as to where to apply pressure in order to actuate the various switches 153 in the RC base unit beneath. Once again, the “inputs” 143 are arranged into four rows and four columns. When the UI component of FIG. 13 is coupled to the RC base unit 106 of FIG. 12, each of the inputs 143 overlies and aligns with a corresponding switch 153 in the switch matrix 152. Thus, when the two components 102, 106 are coupled, the application of pressure to an input 143 actuates a particular underlying switch 153, and further operation is similar to that described above.

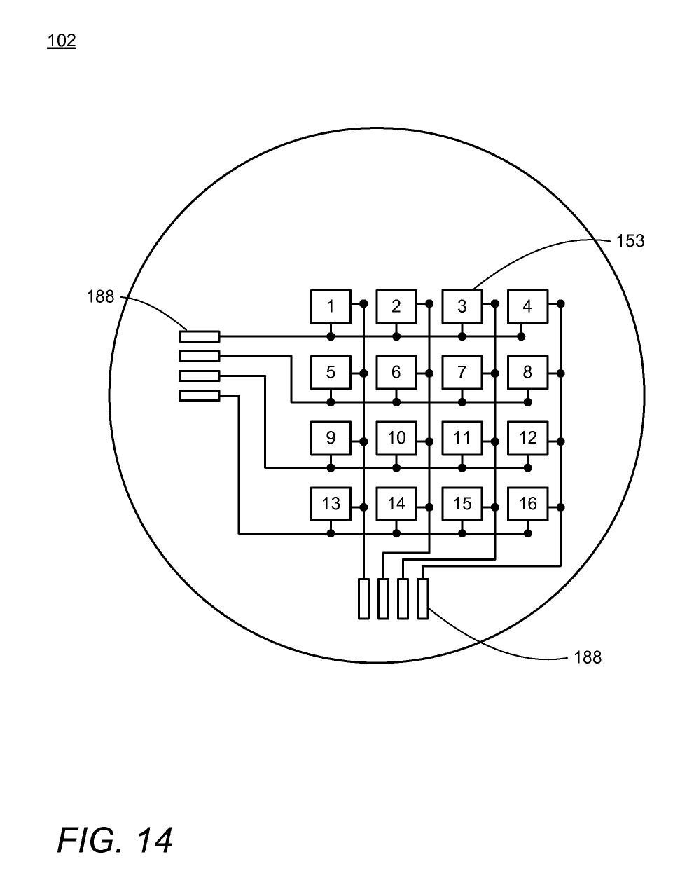

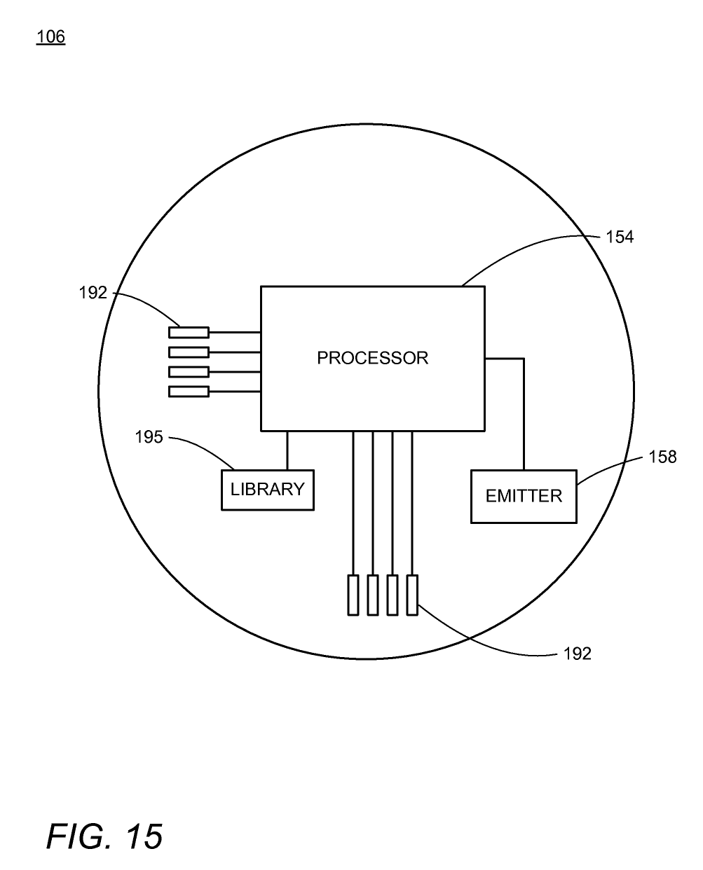

In all of the implementations of the UI component 102 and RC base unit 106 shown in FIGS. 6-13, the UI component 102 has included a user input array 104, but the switches 153 themselves have been disposed in the RC base unit 106. Alternatively, however, it may be preferred for switches 153 to be disposed instead in the UI component 102 of the user control device 100. FIGS. 14 and 15 are top views of the UI component 102 and RC base unit 106 of FIG. 5, respectively, showing simplified circuit diagrams for each, showing an alternative arrangement of switches 153. In this arrangement, the switches 153 are disposed in the UI component 102 and actuated directly by inputs (not shown) arranged on the top surface of the UI component 102. Indeed, the switches 153 of the switch matrix 152 of the UI component 102 may comprise, themselves, the user inputs of the present invention. The UI component 102 further includes a plurality of electrical contacts 188 to which electrical signals are propagated by the switches 153 when actuated by a user via the user inputs. Further, the RC base unit 106 includes corresponding electrical contacts 192 such that when the UI component 102 is coupled with the RC base unit 106, the respective electrical contacts 188, 192 are electrically connected. The electrical contacts 192 in the RC base unit 106 are connected to the processor 154, which is preferably still disposed in the RC base unit 106. Thus, when a user actuates a particular switch 153 in the UI component 102, either directly or via a user input, two electrical signals (designating the row and column, respectively, of the actuated switch 153) are propagated first to the electrical contacts 188 of the UI component 102, then to the electrical contacts 192 of the RC base unit 106, and finally to the processor 154.

It should be noted that in the illustrated arrangement of FIGS. 14 and 15, the processor 154 (and battery or other power source) are still disposed in the RC base unit 106, as it is in the arrangement of FIGS. 11 and 12. Generally, this is preferred embodiment because it is anticipated that the RC base unit 106 would be used and reused with different UI components 102 in the manner described above for purposes more fully described hereinbelow, and thus the relative costs of the interchangeable UI components 102 may be minimized by omitting a separate processor and battery from each one and instead using the processor 154 and battery disposed in the RC base unit 106. However, it will be apparent that a processor (not shown) may instead be placed in each UI component 102 and used either in place of, or in conjunction with, a processor 154 in the RC base unit 106, and that the battery or other power source may instead be disposed in the UI component 102.

Further, it will be apparent that the circuit arrangement shown for identifying the row and column of the actuated switch 153 to the processor 154 may be replaced with other circuitry (not shown) as long as it provides sufficient information from which the actuated switch 153 may be accurately determined.

Upon receiving an electric signal in response to the actuation of a user input of either arrangement of UI component 102 and RC base unit 106, the processor 154 (in accordance with a program that it runs thereon) responds appropriately such as, for example, by causing the emitter 158 to transmit an appropriate signal or set of signals to a targeted device. Generally, the targeted device is the set-top device 50, but in some cases the targeted device may be one of the components of the audio/video system 70. Such components may include, but are not limited to, DVD players, VCRs, CD players, computers, televisions, and the like. The signals transmitted or sent by the emitter 158 are preferably representative of one or more commands, receivable by a corresponding receiver on the targeted device and recognizable by the targeted device as the intended commands. The commands are used to control the targeted device. (The user control device 100 thus preferably is utilized in providing interactive VOD experiences as well as, for example, interactive DVD experiences as set forth and disclosed in the incorporated references.

The emitter 158 is preferably a wireless transmission device, such as a radio frequency (RF) transmitter, an infrared (IR) emitter, an IrDA device, a Bluetooth device, or the like, and is more preferably a conventional transmission device. When the emitter 158 comprises an IR emitter, the emitter 158 is preferably a multiple angled emitter, which helps ensure that transmissions are received by the set-top device 50 (or other targeted component) despite potential line-of-sight obstacles. Alternatively or in conjunction with a wireless device, the emitter 158 may comprise any conducting wire or fiber optic signal generator, and may utilize a parallel port connection, a serial port connection, a USB port connection, or any other suitable, and preferably conventional, wired interface.

As will be appreciated, the appropriate response by the processor 154 to an electric signal received from the switch matrix 152 will be dependent upon the media content being presented and the UI component 102 being utilized. This “dependency” point may be illustrated using the respective implementations of the user control device 100 shown in FIGS. 6 and 7. The implementation of the RC base unit 106 in each user control device 100 is the same, and as shown it may accommodate any number of different UI components 102 having similar or varying input arrangements such as, for example, the UI component 102 of FIG. 6 and the UI component of FIG. 7. Moreover, the media content stored at the head-end system 20 and associated with the implementation of the UI component 102 shown in FIG. 6 may provide for workplace training of employees including, for example, sixteen training lessons to which the sixteen inputs of the FIG. 6 UI component 102 correspond, while in contrast, the media content stored at the head-end system 20 and associated with the implementation of the UI component 102 shown in FIG. 7 may comprise a five act play to which the five inputs of the FIG. 7 UI component 102 correspond. In order for the processor 154, which as noted previously is preferably disposed in the RC base unit 106, to respond appropriately to actuation of a user input of one of the UI components 102, the processor 154 must be instructed how to respond as a function of the particular UI component 102 to which the RC base unit 106 is attached. A signal received from one or more particular switches 153 when a user input 103 of the FIG. 6 UI component 102 is actuated most likely should not result in the same multimedia response, i.e., display of media content, as when a signal is received from the same switches when a user input 111, 112, 113, 114, 115 of the FIG. 7 UI component 102 is actuated. A signal that is received from a switch 153 of the RC base unit 106 when the FIG. 6 UI component 102 is attached may result in the eighth training lesson being presented from the head-end system 20, whereas a signal that is received from the same switch 153 of the RC base unit when the FIG. 7 UI component 102 is attached may result in the third act of the play being presented from the head-end system 20.

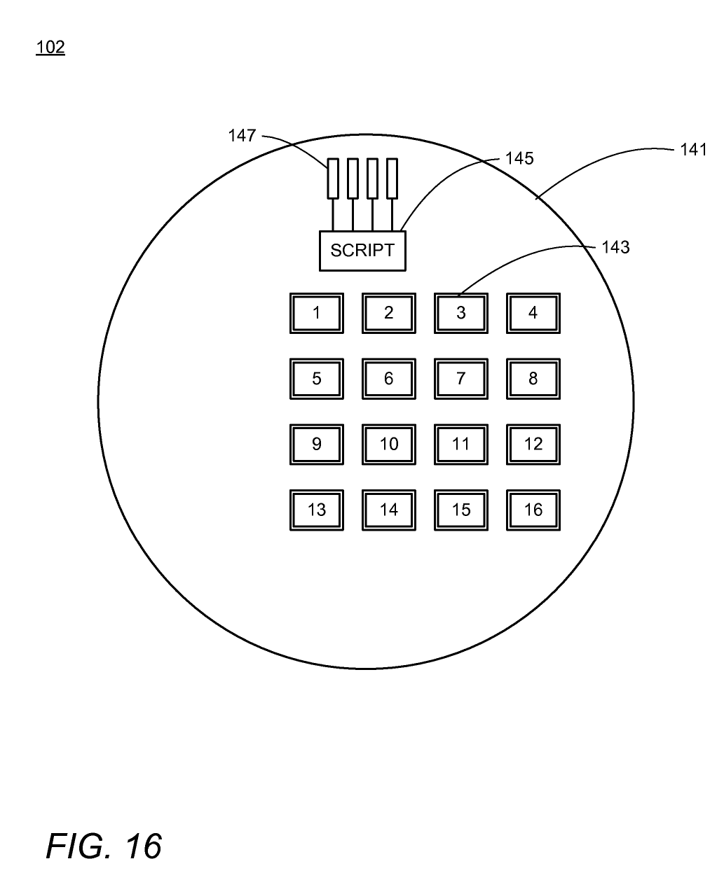

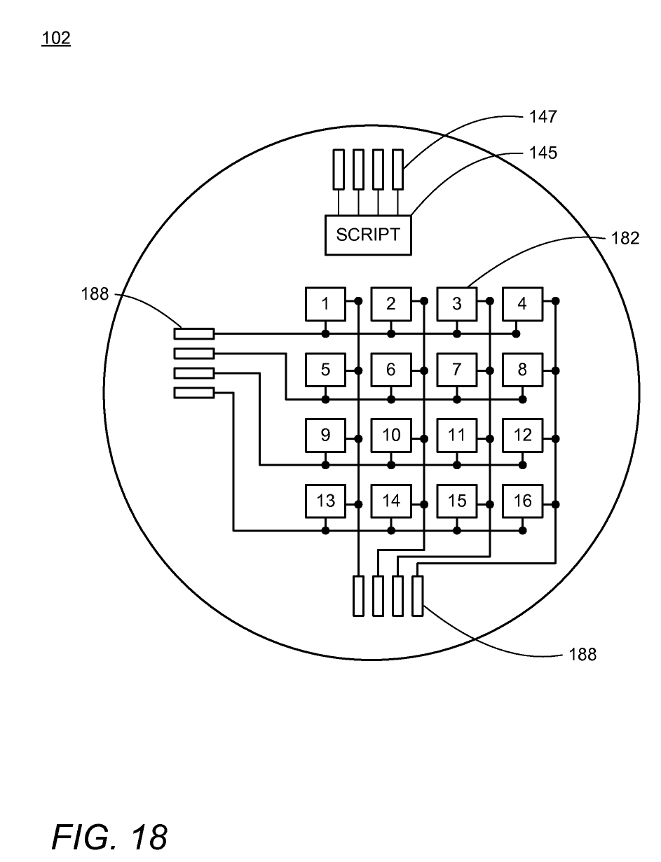

There are a variety of ways to properly instruct the processor 154 of the RC base unit 106 as to how to react when a signal is received. In a first embodiment, each UI component 102 carries UI component-specific software stored in a machine readable medium or memory 145 of the UI component 102. FIGS. 16 and 18 are top plan views of the implementations of the UI components 102 of FIGS. 11 and 14, respectively, with a memory 145 added thereto. This memory 145 represents a controller-independent storage medium (“CISM”). The CISM may form a permanent part of the UI component 102 or, itself, may be detachable from the UI component 102. A characteristic of this implementation is that the CISM physically interfaces with the UI component 102 rather than the RC base unit 106, which is found in yet other implementations of the invention discussed further below.

In preferred embodiments of one or more aspects of the present invention, the software comprises a script that is interpreted by the processor 154, and the program running on the processor is a script engine or script interpreter (hereinafter referred to as “Interpreter”), such that the script is interpreted by the Interpreter. Furthermore, the script stored in the CISM preferably is at least partially compiled. The script essentially comprises control or navigational rules by which the Interpreter determines an appropriate response to receipt of a signal in response to actuation of a user input. By providing a script that is specific to media content stored at the head-end system 20 and associated with a particular UI component 102 at the premises, UI components 102 are able to couple to, and function with, similar or identical RC base units 106; the scripts of the UI components 102 provide the specific control or navigational rules appropriate to the media content to which the UI components 102 correspond; in essence, the script provides the logic by which the Interpreter operates for navigating the particular media content in a highly interactive manner.

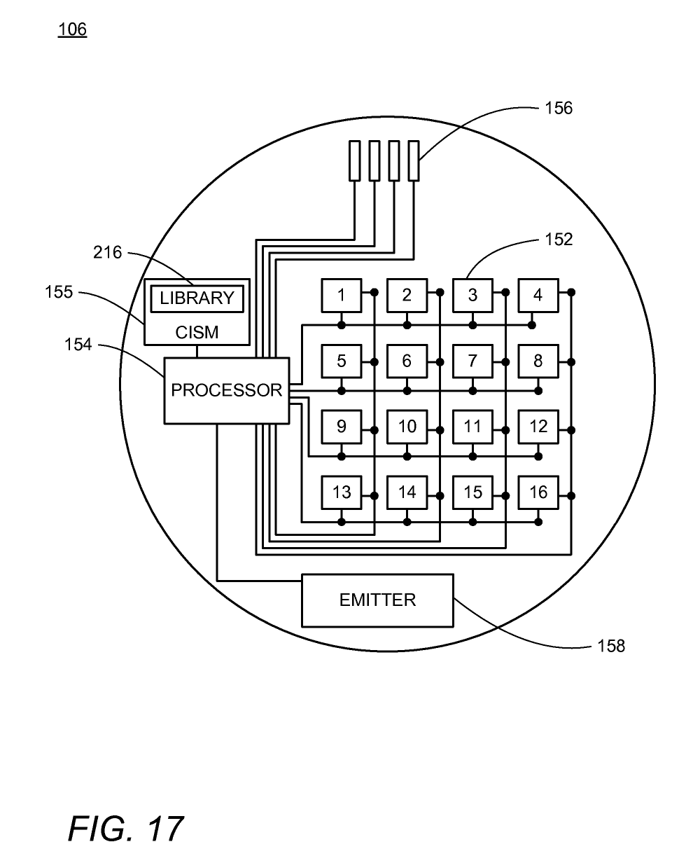

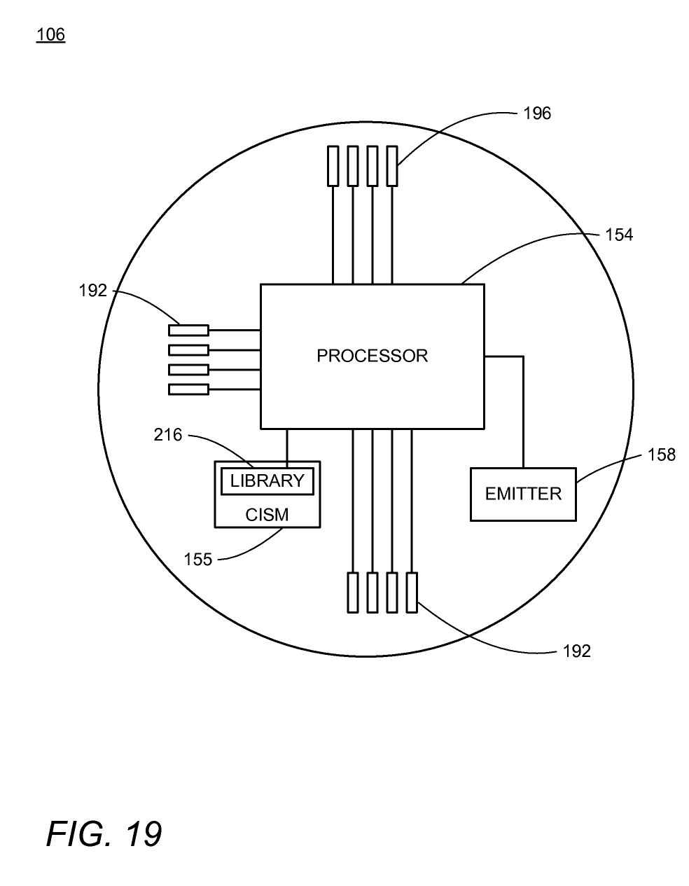

The script is read by the Interpreter, which is resident in the processor 154 disposed in the RC base unit 106, through electrical contacts between the UI component 102 and the RC base unit 106. FIGS. 17 and 19 are top plan views of the implementations of the RC base units 106 of FIGS. 12 and 15, respectively, with electrical connections to the CISM 145 added thereto. As shown in FIGS. 16-19, electrical contacts 147 in each UI component 102 abut, respectively, electrical contacts 156 in each RC base unit 106 such that when a UI component 102 is coupled with an RC base unit 106, the respective electrical contacts 147, 156 are electrically connected. The electrical contacts 147 in each UI component 102 are connected to the CISM 145, and the electrical contacts 156 in each RC base unit 106 are connected to the processor 154. Thus, the script stored in the CISM 145 of any UI component 102 may be communicated to the processor 154 in the RC base unit 106 to which the UI component 102 is coupled. Furthermore, the script is read in its entirety when the UI component 102 is connected to the RC base unit 106, or alternatively, on a case by case basis as a signal is received by the processor 154. The CISM 145 can include, for example and not by way of limitation, a magnetic strip, a removable memory cartridge, a memory disk, a read only memory (ROM) device, an erasable programmable read only memory (EPROM) device, any read only or read write memory device, an EEPROM or FLASH ROM device, an I2C standard device on a serial chip, or any other suitable magnetic or optical media memory storage device.

In further accordance with the invention, the script of a particular UI component 102, while dependent upon the media content stored at and provided by the VOD head-end system 20, is not dependent upon, and thus is independent of, the particular host system, e.g., the particular set-top device 50 or audio/video system 70 that is used for presentation of the media content. Instead, the RC base unit 106 is dependent upon the particular host system in that the RC base unit 106 includes the particular communication protocol and codes of the host system so that appropriate commands controlling the media presentation may be communicated to the host system. In order to accomplish this, the RC base unit 106 preferably includes a library 216 of communication protocols and codes for different host systems, whereby the same RC base unit 106 can be used with different host systems similar to the multiple use capability of “universal” remotes with various electronic devices of different manufacturers. This may be accomplished in a variety of ways. For example, as shown in FIGS. 12, 15, 17 and 19, each RC base unit 106 may include a machine executable medium 155 that contains such a library 216. Of course, the particular media devices that are used in a particular environment will need to be identified to the RC base unit 106 for appropriate identification by the RC base unit 106 of the device-specific commands to be selected from its library 216. The RC base unit 106 also preferably includes upgrade capabilities, whereby the library 216 can be updated over time with additional communication protocols and codes to ensure compatibility with future host systems and components thereof. Each protocol enables the Interpreter to communicate codes representing commands to the host system via the emitter 158 for control of the media presentation. By making the UI component 102 independent of the host system but dependent upon the media content stored and retrieved from the head-end system 20, by making the RC base unit 106 independent of such media content but dependent upon the particular host system at the premises, and by making the UI components 102 interoperable with different RC base units 106, the present invention enjoys great flexibility and utility. Indeed, a single RC base unit 106 can serve a wide variety of UI components 102, and a single RC base unit 106 can be utilized with a wide variety of host systems.

With additional regard to the library 216 of communication protocols of the RC base unit 106, the Interpreter may access and read command codes of a particular host system as part of an initialization process when the UI component 102 is coupled to the RC base unit 106, or the Interpreter may read command codes periodically or in response to actuation of a user input. Upon receipt of a signal from one of the user inputs, the Interpreter first refers to the script for the appropriate response, and then refers to the particular protocol and command or commands for the host system, as reflected in the protocol for that host system, in order to determine the appropriate response as identified with reference to the script. The Interpreter then causes the appropriate signals to be transmitted to the host system by the emitter 158. For example, an appropriate response to a signal that is generated by a user input on the UI component and received by the Interpreter may be, pursuant to the current script, to access a particular point in time in a particular program, begin play, and then pause presentation of the program until another signal is received as a result of a subsequent user actuation of another user input. To accomplish this response, the Interpreter determines the appropriate codes representing commands to communicate to the host system preferably via transmitted wireless signals, as described above.

With additional regard to the Interpreter, the script language preferably comprises a complete media programming language written in modular fashion that includes features of conditional branches, states maintained, and variable data created, read, and updated. The Interpreter also preferably is backwards-compatible for interpreting scripts written for older versions of the Interpreter, thereby allowing the software language to evolve without requiring hardware or firmware upgrades in the field. The script language preferably contains high level verbs that allow users to easily control interactive media, and contains all of the normal programming constructs, such as conditional statements, loops, macros, parameters, variable data, data storage, etc.

Each script is preferably developed utilizing an application programming interface (API) which can be a simple scripting language based upon standard XML protocols. The script language also preferably utilizes standards based on widely accepted XML syntax to provide the mechanism for scriptable media interactivity. Robust conditional logic and an event-driven model enable considerable flexibility in the adaptability of instructions, making complex forms of interactivity possible.

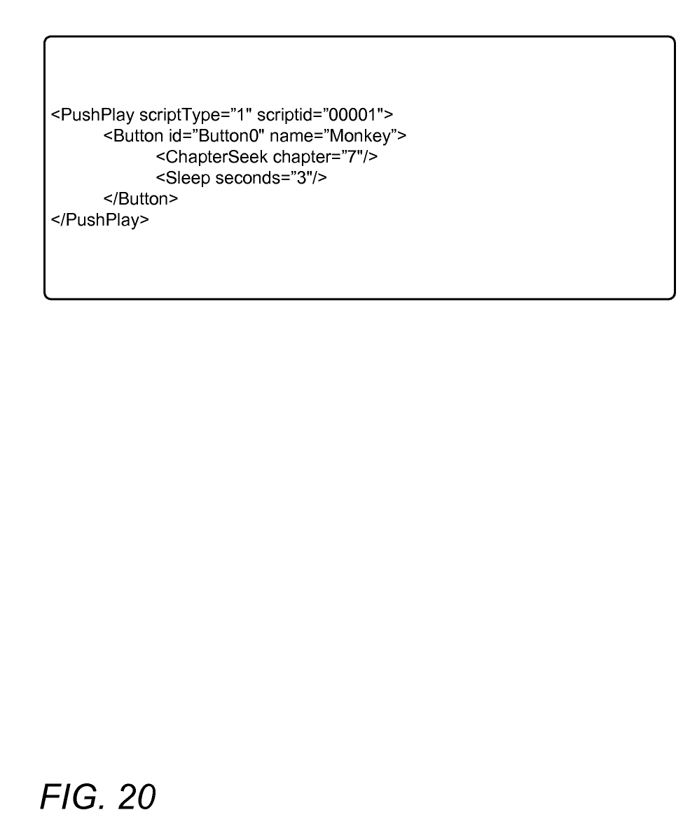

An exemplary script for an input comprising a button is shown in FIG. 20. In accordance with this simple example, when a button (not shown) identified as the “Monkey” button is pressed, the presentation of the media content of Chapter 7 of the appropriate title or program begins. Furthermore, in accordance with the invention, this media content is retrieved from the VOD head-end system 20. In such an arrangement, the “Monkey” button may have indicia representing a monkey displayed on it, and Chapter 7 may relate to monkeys.

With regard to further detail of the script structure, the syntax is XML elements and attributes. Commands (verbs) are XML elements. Parameters are XML attributes. Using this syntax, the script language is easily created or changed. Commands can be upgraded by modifying the parameters (attributes). New commands can be added or dropped.

For example, if a command to issue the “Play” command to a set-top device 50 to begin presenting a program from the VOD head-end system 20 on the audio/video system 70, then the following command may be utilized:

<Play/>

If later the behavior of this command is to be changed, then parameters (attributes) could be added. For example, a parameter “seconds” could be added to the command. This parameter, if present, would continue the “Play” command for x seconds and then pause. Such a command may appear as follows:

<Play seconds=“10”/>

Furthermore, such changes take place without modification of a compiler since they adhere to the XML syntax.

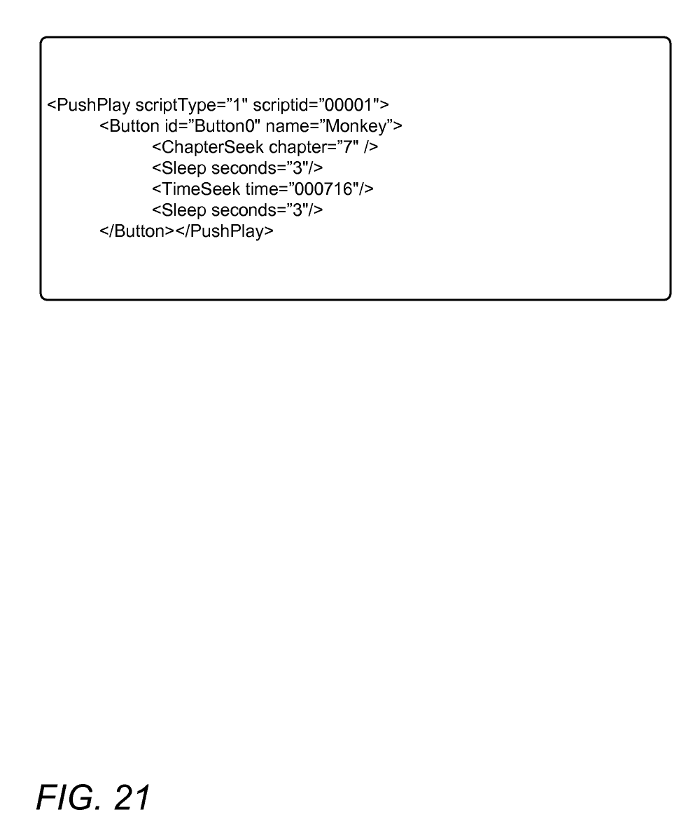

Another aspect of XML that is utilized in the script language is the concept of “child elements,” which provide many advantages. The primary use of this concept is to group together a plurality of commands that are to be executed when a particular user input (such as a button) is actuated. For example, FIG. 21 illustrates a group of commands that are to be issued when the button identified as the “Monkey” button is pressed. This concept may also be used for macros.

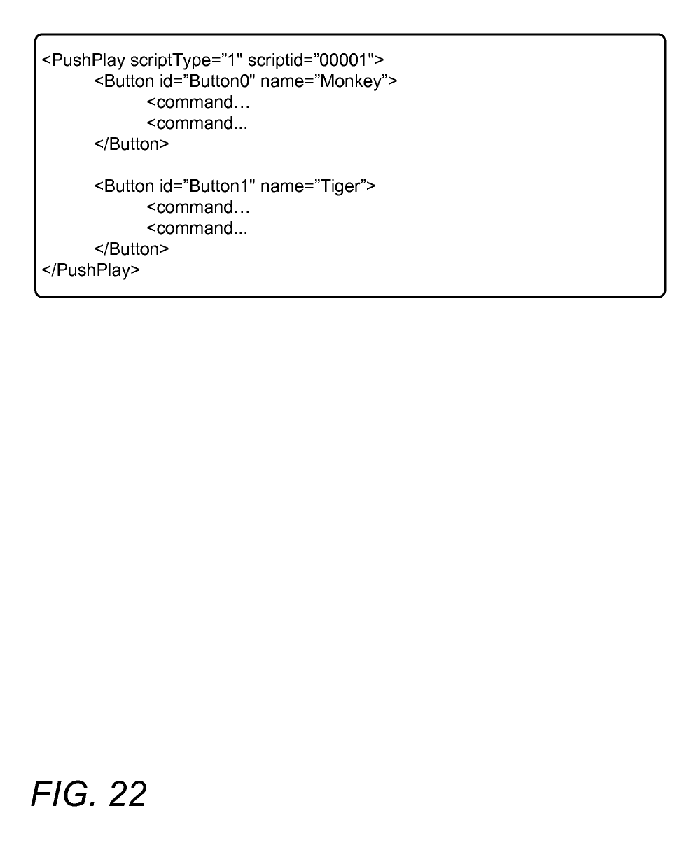

As will be apparent from the foregoing, a script in accordance with preferred embodiments of one or more aspects of the present invention includes a collection of “media-specific,” “device independent” commands for controlling media presentation, as illustrated in FIG. 22.

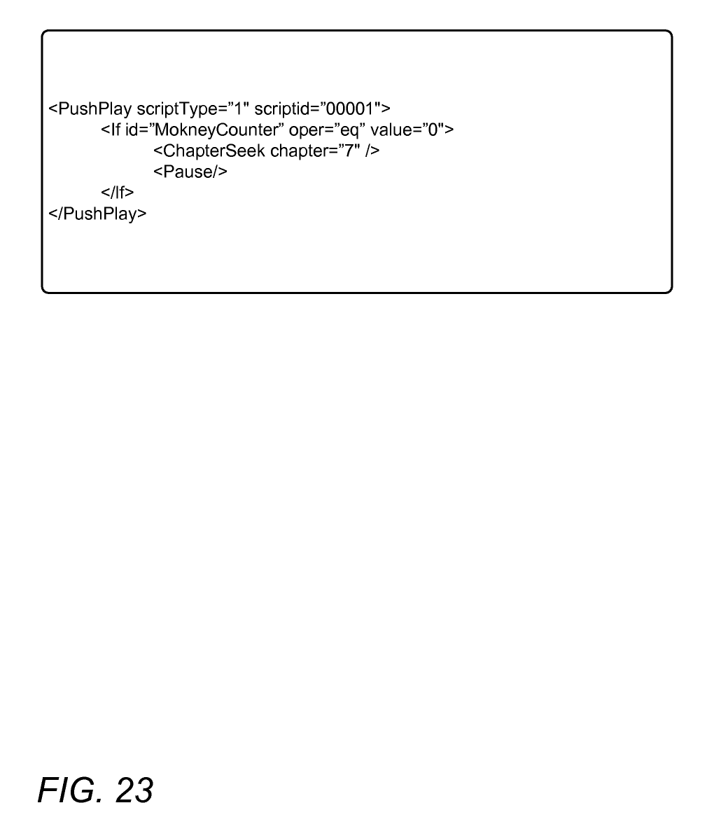

An example of a conditional statement in a script is shown in FIG. 23. In a conditional statement, all child elements (commands) are executed if the condition is true.

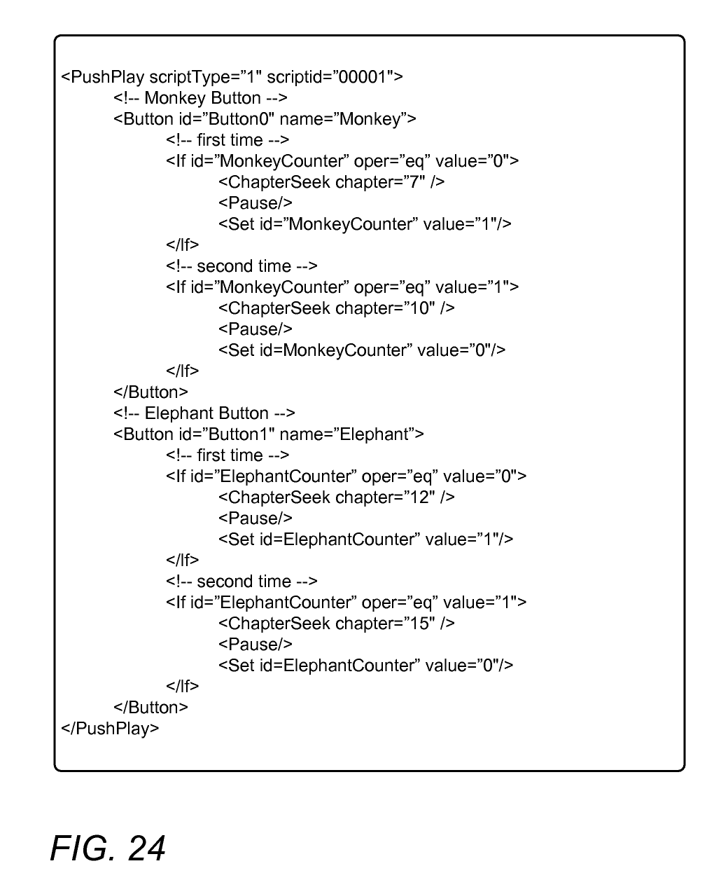

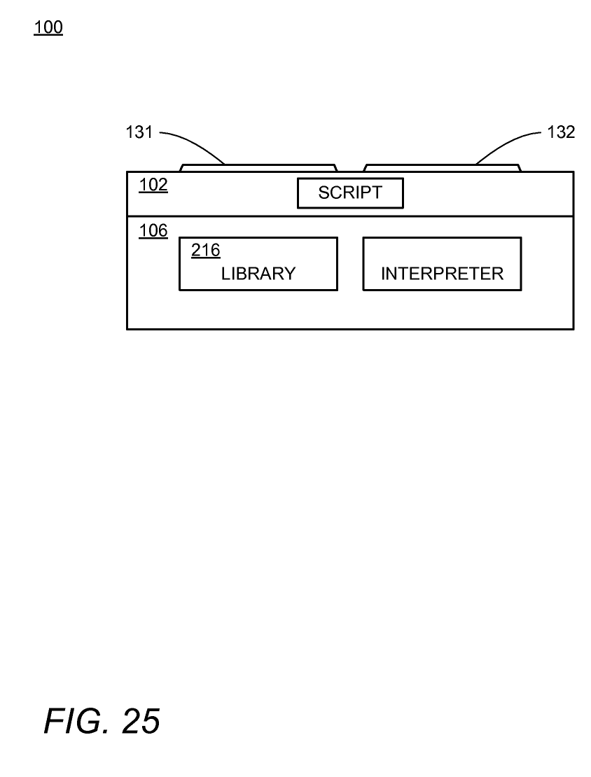

FIG. 24 is a more complete exemplary script illustrating several of the aforementioned concepts, and FIG. 25 is a schematic diagram of a user control device 100 for which the script of FIG. 24 is designed. The user control device 100 includes a UI component 102, having at least a button designated as the “Monkey” button 131 and another button designated as the “Elephant” button 132, and an RC base unit 106, having a library 216 and an Interpreter by which appropriate signals are able to be sent for controlling presentation of media content. The user control device 100 also incorporates the script of FIG. 24, for example using a CISM 145 as shown in FIGS. 12 and 17. Together, the script of FIG. 24 and the user control device 100 of FIG. 25 may be particularly appropriate for use with an educational video, stored on the VOD head-end system 20, about animals. According to the script of FIG. 24, when the Monkey button 131 is pressed, the media content of Chapter 7 of a program from the VOD head-end system 20 is presented on the audio/video system 70 via the set-top device 50. When the “Monkey” button 131 is pressed again, the media content of Chapter 10 is presented. When it is pressed again, it reverts back to Chapter 7. On the other hand, when the “Elephant” button 132 is pressed, the media content of Chapter 12 of a program from the VOD head-end system 20 is presented on the audio/video system 70 via the set-top device 50. When the “Elephant” button 132 is pressed again, the media content of Chapter 15 is presented. This exemplary code demonstrates the robustness of the present invention in providing an appropriate response to actuation of a user input based on prior history of the user session during the presentation.

The operation of the script of FIG. 24 in conjunction with the user control device 100 of FIG. 25 may be further explained as follows. When the “Monkey” button 131 is pressed, the Interpreter searches the script to find the command to execute for this button 131. Upon finding the appropriate command in the Script, the Interpreter checks a “MonkeyCounter” flag in order to determine which chapter of the program to display. If the flag is set to 0, the Interpreter concludes that Chapter 7 is to be displayed and then sets the flag to 1. If, on the other hand, the “MonkeyCounter” flag is already set to 1, then the Interpreter concludes that Chapter 10 is to be displayed and then sets the flag to 0. A corresponding method is utilized with respect to alternative actuation of the “Elephant” button 132.

As demonstrated by the illustration of FIGS. 24 and 25, the effect of pressing the same button may be dynamic in nature. In other words, the script may be programmed such that the first time a button 131, 132 is pressed, a respective first chapter is displayed. On the second press of the same button 131, 132, a different chapter is displayed. It should also be noted that in the script of FIG. 24, no reference is found reflecting that the set-top device 50 (or other device) is of a particular type or brand; i.e., the script is independent of the media device. Specific codes for executing the commands in the script on the particular set-top device 50 (or other device) are found in the library 216 of the RC base unit 106.

Scripts may be created with any available and suitable text editor. Additionally, scripts can be compiled into a machine independent format suitable for placing in script storage. Compiling a script can greatly reduce its size and allow its maintenance in machine independent format. A “drag and drop” visual editor can aid programming in the overlay software language and enable a producer with little programming skills to create interactivity instructions for a specific UI component 102. An integrated set-top device 50 can allow editing, playback and testing from a single workstation. More technical users can be provided the option of editing using a more traditional development interface.

A programmer or developer adds commands to a “Table of Commands” in the Interpreter. The developer then provides the address of a software routine that will be called when the script so indicates by reference to a command of the Table of Commands. For example, when a “Sleep” command is interpreted, the referenced program code may perform the following:

a) Fetch the “seconds” parameter,

b) Fetch the “milliseconds” parameter,

c) Delay program execution for the appropriate amount of time as specified by the parameters.

If it were desired that the command be changed to have parameters for minutes and seconds instead of seconds and milliseconds, then it would be extremely easy to change the program code to support the different parameters. Moreover, no changes in a compiler or the Interpreter would be required. Thus, for a command to be removed, it only need be deleted from the Command Table and the code thereof removed that would otherwise be called in execution of the command. Conversely, to add a command, an entry in the Command Table only need be made with appropriate reference to the code for executing the command.

In accordance with preferred embodiments of one or more aspects of the present invention, the script language preferably includes the following commands that relate to set-top devices 50 adapted to receive and present media content from a VOD head-end system 20: MENU (stops program playback and displays a primary menu for the current program); SUBMENU (stops program playback and displays a secondary menu); RESUME (returns to playback mode from menu mode at the same program location as when the menu was invoked); BACK (returns the display from a submenu to its parent menu); PLAY (causes the set-top device 50 to start playing a selected program or resumes play of a paused program); STOP (stops the playing of the program); PAUSE (pauses the playing of the program); NEXT (locates and plays the next chapter or section of the program; will loop); PREVIOUS (locates and plays the previous chapter or section; will loop); SECTIONSEEK (seeks and plays a particular chapter or section, specified by section or chapter number, in the current program); TIMESEEK (seeks to a specific point of time in the program, measured from the beginning of the program; parameters include hour, minute, and second); FASTFORWARD (starts fast forwarding through the program); FASTREVERSE (starts fast reversing through the program); PUSHBUITON (simulates a button press on a conventional remote control device); and PUSHNUMBERS (simulates pressing the number buttons on a conventional remote control device).

Basic commands that are found in all scripts regardless of the actual implementation of the present invention preferably include: PUSHPLAY (defines a new script; parameters include script type and id); BUITON (defines commands that will be executed when signal for button is received); TRICKPLAY (defines a macro, which is a collection of commands that typically will be called upon multiple times; parameters can be passed that modify macro behavior); IF (Conditional command; will execute block of commands if condition is true); SET (sets value of a variable data item); ((FETCH) (returns value of a variable); INCREMENT (increments a variable with a range; when maximum limit is reached, will restart a minimum value); APPEND (appends a string value to a variable); BUTTONSON (enables reaction to button presses); BUTTONSOFF (disables reaction to button presses); SLEEP (sleeps for time period; awakens upon input actuation from the UI component 102); and SLEEPHARD (sleeps for time period; does not wakeup upon input actuation from the UI component 102).

In a feature of one or more aspects of the present invention, the Interpreter also monitors and records historical data regarding session use of a user control device 100. This collected data may be utilized to modify future sessions or provide feedback to users. Such data may include the number of times a particular user input is actuated, the performance level of a user in interacting with an interactive media presentation, or the number of “right” answers that are provided by a user in response to certain media content, such as an interactive educational video. Memory in the RC base unit 106 and or the UI component 102 may be utilized in storing such monitored data. Instructions for monitoring and recording the data, if any, are preferably included in the script.

In another feature of one or more aspects of the present invention, the RC base unit 106 is a multimode device and the Interpreter maintains the state of the RC base unit 106, whereby different responses may be provided as a function of the current state of the RC base unit 106 upon receipt of the same signal. For example, a mode switch may be provided, such that when the mode switch is set to a first position, actuation of a specific user input may initiate the playing of Chapter 10 of a media program, and such that when the mode switch is instead set to a second position, actuation of the same user input may initiate the playing of the next chapter, or the playing of Chapter 36, for example.

In yet another feature of one or more aspects of the present invention, users themselves are able to “write” scripts for their own personal use. In this regard, a software program or one or more macros are provided that automate the script writing function, whereby users do not have to actually know any particular scripting language in order to create and customize scripts for their use and enjoyment in controlling media events.

In view of the foregoing detailed description of preferred embodiments of one or more aspects of the present invention, it readily will be understood by those persons skilled in the art that these aspects of the present invention are susceptible of broad utility and application. While various aspects have been described in certain contexts, the aspects may be useful in other contexts as well. Many embodiments and adaptations of these aspects of the present invention other than preferred embodiments described herein, as well as many variations, modifications, and equivalent arrangements, will be apparent from or reasonably suggested by the foregoing description, without departing from the substance or scope of the present invention.

Furthermore, any sequence(s) and/or temporal order of steps of various processes described and claimed herein are those considered to be the best mode contemplated for carrying out these described aspects of the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions.

Accordingly, while one or more aspects of the present invention have been described herein in detail in relation to preferred embodiments, it is to be understood that this detailed description is only illustrative and exemplary of these aspects of the present invention and is made merely for purposes of providing a full and enabling disclosure of the invention. The foregoing disclosure is not intended, nor is to be construed to limit, the present invention or otherwise to exclude any such other embodiments, adaptations, variations, modifications and equivalent arrangements.

For example, one exemplary non-conventional structure for the user control device 100 is shown in FIG. 9, wherein the apparatus for controlling the media presentation is disclosed as being a child's activity table. In other alternative non-conventional structures or arrangements, the apparatus may be constructed as a “laptop” unit to be placed on or over the lap of a seated user and can be constructed as a tray like unit for coupling with, for example, a child's chair having rails for receiving a tray.

In addition thereto, the UI component 102 of FIG. 6, for example, has been illustrated with rectangular keys 103, while the UI controller 102 of FIG. 7, for example, has been illustrated with circular keys 111, 112, 113, 114, 115. However, any shape of the keys may be used in accordance with one or more aspects of the present invention and, in fact, the keys may be shaped in a manner that indicates the media content presented by user actuation of the keys. For instance, the keys of a UI component 102 may be shaped as alphabetic letters, with the shape of the keys comprising in this instance the aforementioned indicia of the user inputs. Indeed, the materials, shapes, and sizes of UI controllers 102 are completely variable. A UI controller 102 may comprise a touch screen that defines a graphical user interface, or a sheet of cardboard with imprinted buttons. User inputs may be spring loaded buttons that are, for example, plastic or rubberized. Exemplary user inputs include mechanical actuators that couple to electrical switches of an RC base unit 106. Other examples include user inputs that are electrical switches that couple to conductive contacts of an RC base unit 106.

In any case, each UI component 102 preferably is specific to the medium content of a particular medium unit, with user inputs that relate to its purpose and content, and look-and-feel branding based on the brand and/or content of the media program from the head-end system 20. A UI component 102 can have any size, shape, and form of user inputs that makes sense for its content and educational purpose. For example, the UI component 102 and/or the RC base unit 106 could resemble a book, wherein the turning of the pages of the book triggers a media event related to the content of the current page(s) of the book being viewed. The UI component 102 also could take the form of a mini-piano, wherein certain notes or chords trigger particular video and/or audio presentations. More complex interactivity formats, like the “question-and-answer” format, could be used to teach and test specific notes and chords in learning to play the musical instrument. The UI component 102 could further include a dance mat, wherein certain step combinations would trigger particular video and/or audio presentations. A UI component 102 also could comprise a character or doll, wherein pressing of certain parts of the body would trigger media events for teaching about the body parts, etc. The UI component 102 and/or the RC base unit 106 also could include a voice recognition component, wherein voice commands to trigger media events would be enabled.

Additionally, within the scope of the inventive system, there are various alternatives to storing scripts in a script element of a UI component 102 for access by the Interpreter. Such alternatives include dynamically reading and accessing the script by the Interpreter, either wirelessly (IR, IRDA, radio) or wired (rs232, Ethernet, USB, etc.). This is especially convenient when the script has been compiled, making it easily portable to many different environments. Of course, the script that is accessed by the Interpreter would still need to be dependent upon the UI component 102 that is used with the RC base unit 106.

It will also be appreciated by those having ordinary skill in the art that the foregoing description of one or more aspects of the present invention encompasses not only presentation of media content, but control of other media events utilizing an RC base unit 106 and removable UI component 102. Thus, for instance, a command to record media content can be communicated to a host system in accordance with these aspects of the present invention with, for example, the UI component 102 being associated with the media content to be recorded.

Finally, while these aspects of the present invention have been described with regard to preferred embodiments directed to children toys and/or child education, the present invention is useful in a wide range of applications including educational tools, product demonstrations, healthcare applications, and entertainment purposes for people of all ages and interests.

In addition to all of the foregoing, additional implementations and preferred embodiments are now described.

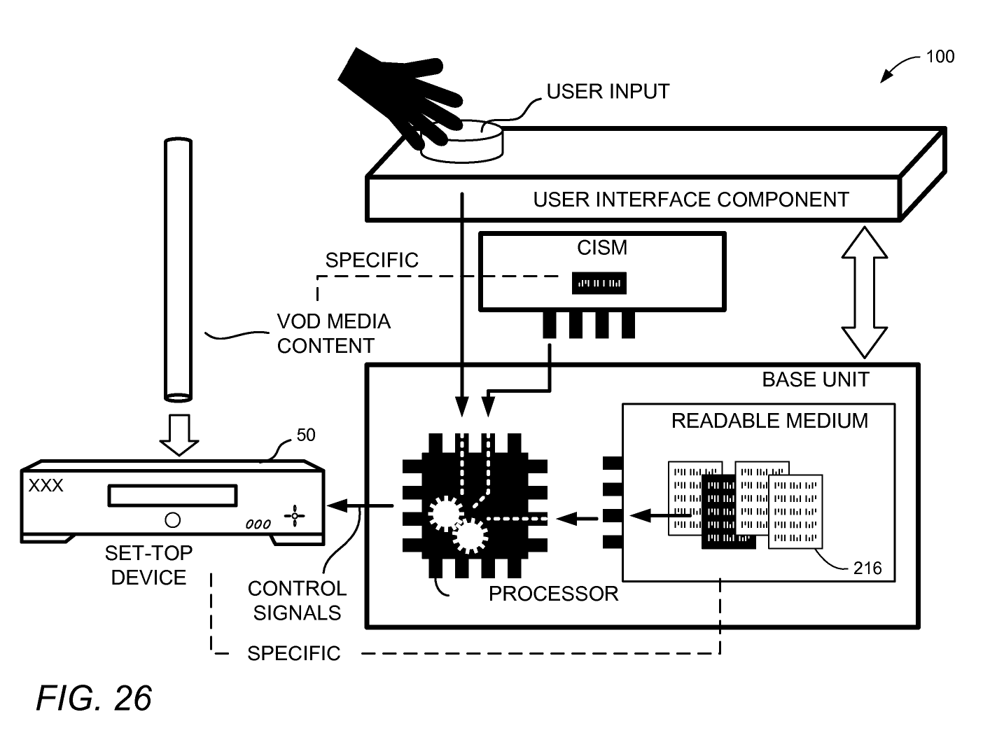

In this regard, FIG. 26 is a schematic diagram of a first implementation of the components of an interactive video on demand system 10 that are located at the user's premises. In general accordance with the foregoing detailed description, this first implementation includes a set-top device 50, a base unit, and a user interface component having user inputs. The apparatus further includes a memory or CISM having machine executable instructions specific to VOD media content but not specific to any particular set-top device 50 or other device (“Device Independent Instructions”). As described previously, the controller includes a processor, a program executed by the processor that reads and/or interprets the Device Independent Instructions, and a library 216 of communication protocols and codes for communicating by the base unit, to the set-top device 50, control signals relating to the media event (“Device Specific Instructions”) based on the Device Independent Instructions. The program, vis-à-vis the processor, in response to actuation of a user input of the UI component, performs the steps of reading and/or interpreting Device Independent Instructions, and causing commands to be communicated to the set-top device 50 utilizing the Device Specific Instructions of the library 216. Notably, the UI component in this aspect of the invention comprises a removable user interface component that couples directly with the controller.

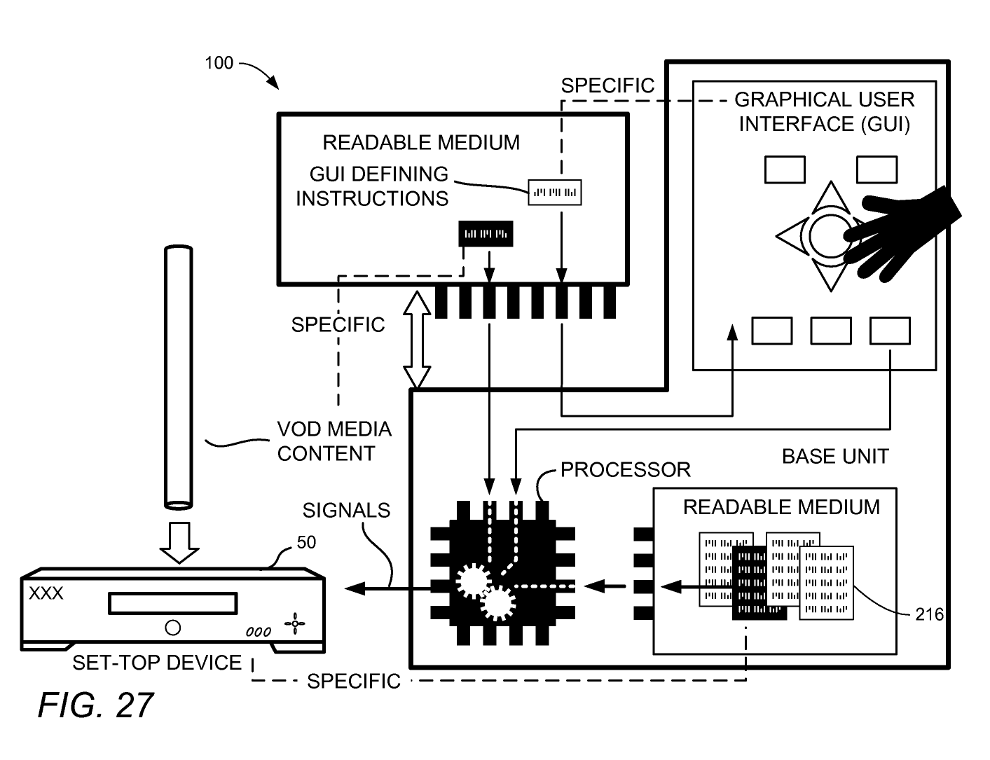

By contrast, FIG. 27 is a schematic diagram of the user premises components of a second implementation of an interactive video on demand system 10. In this implementation, a user control device 100 includes, in lieu of a removable user interface component, a graphical user interface (“GUI”) that is displayed on a screen, preferably but not necessarily disposed on the base unit, and includes a plurality of user inputs for actuation thereof. The GUI display screen preferably is a touch sensitive screen that displays the user inputs and generates an input signal upon the touching of the area of the screen defining a user input. The user inputs of the GUI preferably are specific to the VOD media content. In this regard, the user inputs of the GUI preferably appear in arrangements each specific to a particular media content selection. For example, the GUI also may include user inputs representing navigational functions that are related to the particular selection. In a particular commercial embodiment, the user inputs of the GUI comprise a pictorial representation of the alphabet, the machine readable medium having the GUI defining instructions (the “GUI Defining Instructions”) and the Device Independent Instructions comprise a cartridge that commercially is sent to a user on a subscription basis or via some other distribution method, and the VOD media content has interactive educational content directed to alphabet lessons for children.

The CISM comprises a removable storage medium that removably couples to the base unit, and includes software that is specific to the media content (the “the “Device Independent Instructions”) as well as machine executable instructions for providing the GUI on the display screen. The GUI Defining Instructions define the user inputs of the GUI that provide the user with virtual buttons for interactive viewing of the media content. The base unit processor reads these instructions for providing the GUI and for interpreting actuation of user inputs of the GUI and determining appropriate actions to take based on the “Device Independent Instructions.”

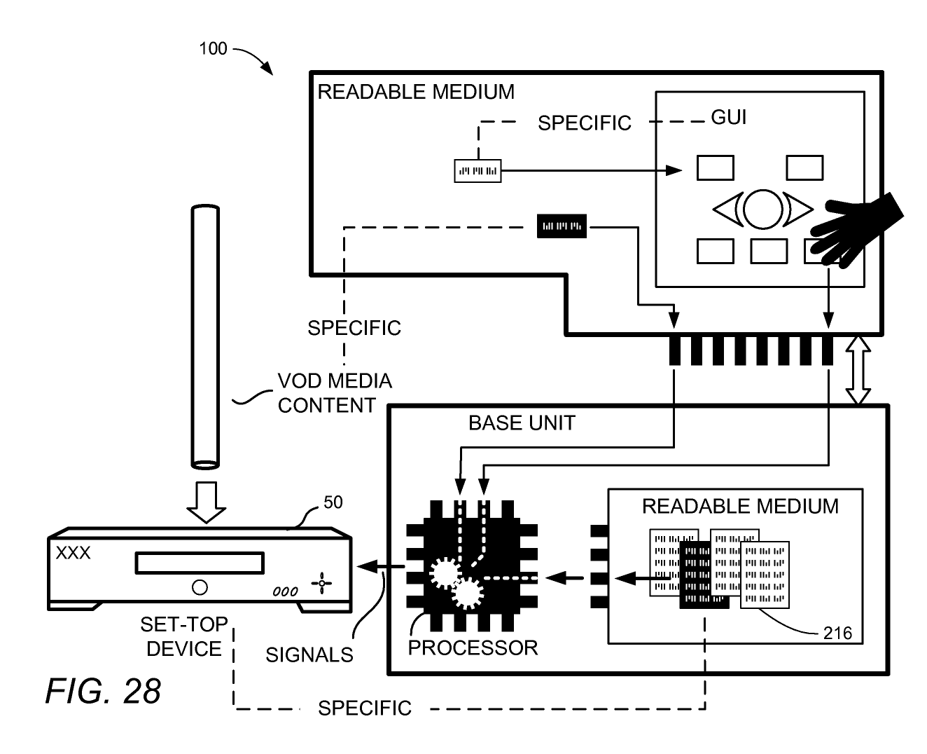

In accordance with yet another aspect of the present invention, FIG. 28 is a schematic diagram of the user premises components of a third implementation of an interactive video on demand system 10. In this implementation, a user control device 100 includes a removable user interface component that incorporates the screen on which the graphical user interface (GUI) is displayed. The removable user interface component removably couples to the base unit, and includes the Device Independent Instructions that are specific to the VOD media content as well as GUI Defining Instructions for providing the GUI on the display. The base unit processor reads these instructions for providing the GUI and for interpreting actuation of user inputs of the GUI and determining appropriate actions to take based on the “Device Independent Instructions.” In a variation thereof, the removable user interface component may include a separate processor that reads the GUI Defining Instructions for providing the GUI. The instructions read for interpreting actuation of the user inputs may or may not be specific to particular media content.

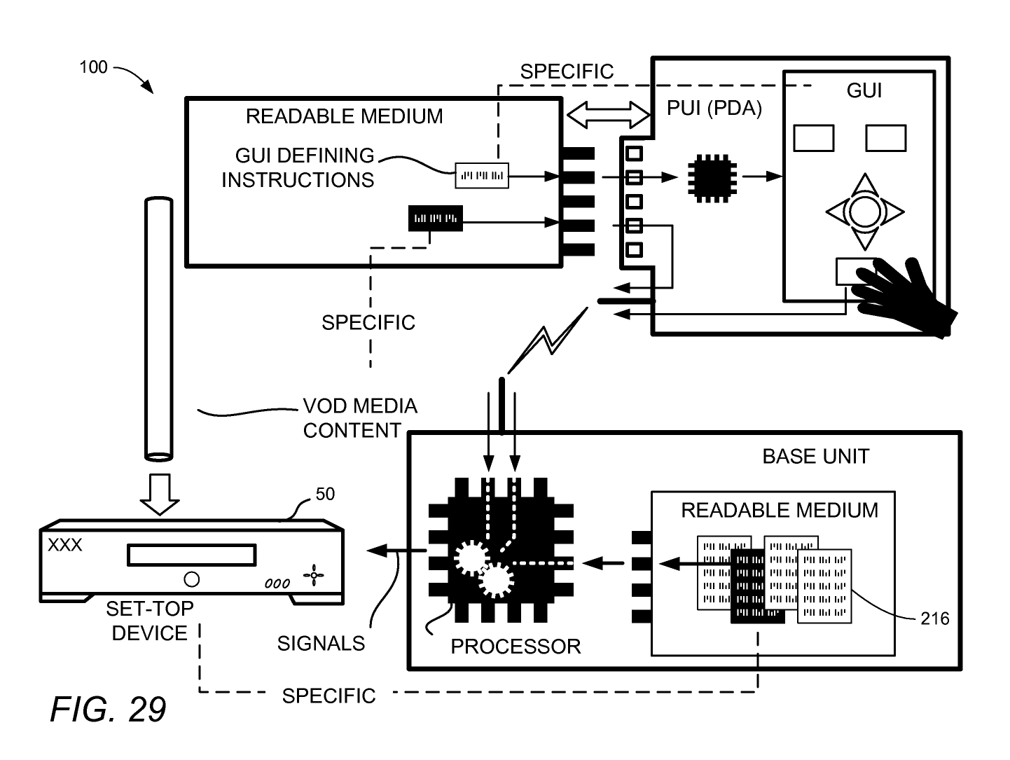

In accordance with yet another aspect of the present invention, FIG. 29 is a schematic diagram of the user premises components of a fourth implementation of an interactive video on demand system 10. In this implementation, a user control device 100 includes a peripheral user interface, preferably implemented in a personal digital assistant (“PDA”) or the like, on which the GUI is displayed, and the CISM comprises a memory card, such as a smart card, that is removably inserted into the PDA, and includes therein the GUI Defining Instructions for reading by the processor of the PDA for providing the GUI on the display. The processor additionally reads the Device Independent Instructions contained in the smart card for interpreting actuation of user inputs of the GUI and determining appropriate actions to take. The instructions read for interpreting actuation of the user inputs preferably are specific to the particular VOD media content. The PDA preferably communicates wirelessly with the base unit, and the Device Independent Instructions are available to the base unit processor through this communications link between the PDA and the base unit. The library of codes for sending device specific signals, preferably representative of commands, to the set-top device 50 (Device Dependent Instructions) also preferably are accessible by the base unit processor.

A plurality of user inputs of the PUI are defined according to the instructions on the CISM/smart card as touch sensitive areas of the GUI visible on the screen for selection and actuation by a user. Upon actuation of one of the user inputs, communication is sent from the PUI (PDA) to the base unit prompting the base unit processor to perform one or more of the Device Independent Instructions, and based thereon, the base unit processor performs one or more of the Device Dependent Instructions resulting in the base unit sending a signal, preferably representative of a command, to the set-top device 50 thereby controlling a presentation of the VOD media content.

It will be apparent that although in FIG. 29 the PUI is shown to communicate with the base unit via a wireless communications link, in another embodiment within the scope of the present invention, the PUI may communicate with a base unit through one or more electrically conductive connections such as one or more wires that optionally releasably couple a PUI to a base unit through one or more plug and socket junctions or suitable electrical ports. Suitable wireless transmitters include, but are not limited to, infrared transmitters and radio frequency transmitters. Furthermore, it will also be apparent that a PUI may be powered by replaceable or rechargeable batteries, or through an electrical cord having a plug that is received by a typical power outlet available in homes and businesses. In yet another embodiment, a PUI may communicate through a releasable cabled connection in the fashion of a plug and play device. Power for the PUI can be provided through the releasable cabled connection, or by batteries, or by a separate electrical cord. In yet another embodiment, a PUI is capable of both wireless and cabled communication with a controller according to the preference of a user at the time of use. Moreover, in a preferred embodiment, the communication coupling of a PUI to a controller is separable. Various embodiments of a PUI can be conveniently placed or carried by a user allowing a user to direct a presentation from a location spaced from a controller.

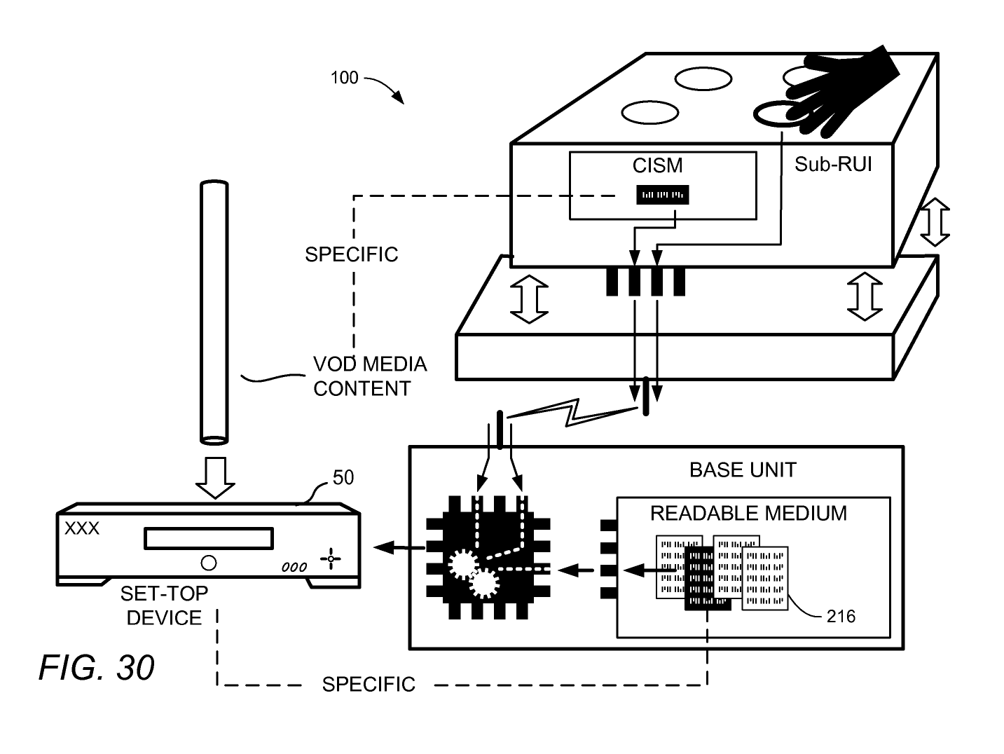

A variation of an embodiment of a PUI is shown in FIG. 30, which is a schematic diagram of the user premises components of a fourth implementation of an interactive video on demand system 10. In this implementation, the PUI comprises a communications component and a sub-RUI. The communications component communicates with the base unit, and the sub-RUI is disposed the CISM, having the Device Independent Instructions relating to a particular VOD media content accessible by the set-top device 50. The Device Independent Instructions on the CISM are available to the base unit processor through a communications link between the communications component and the base unit. Also, the library 216 of codes for communicating signals for controlling the set-top device 50 is preferably accessible by the processor. In certain preferred embodiments of this aspect, the sub-RUI also removably couples to the base unit rather than just to the communications component, thereby providing alternative arrangements available for selection by a user. In other words, within the scope of the present invention, a user interface may be provided that can be removably coupled to a base unit as an RUI and may be alternately removably coupled to a communications component of a PUI as a sub-RUI. Thus a user may learn familiarity with a particular user interface and use it by choice alternately as a RUI coupled removably to the base unit or as a sub-RUI coupled removably to a communications component of a PUI.

Though the embodiment of the communications component illustrated in FIG. 30 is shown to communicate wirelessly with the base unit as facilitated by a transmitter, another embodiment of a communications component within the scope of the present invention communicates with a base unit through one or more electrically conductive connections such as one or more wires that optionally releasably couple a communications component of a PUI to a base unit through one or more plug and socket junctions or suitable electrical ports. Suitable wireless transmitters include, but are not limited to, infrared transmitters and radio frequency transmitters.

In FIG. 30, a plurality of user inputs of the sub-RUI are available for selection and actuation by a user. Various embodiments of suitable user inputs include, but are not limited to, electrical switches, touch sensitive membrane switches, electromechanical buttons, and touch sensitive areas of a GUI visible on a display screen. In response to actuation of a user input, one or more signals are communicated to the base unit. A program in machine readable medium executed by the base unit processor is prompted to access one or more of the instructions relating to the particular VOD media content, access one or more of the instructions of the library 216, and based thereon, the base unit communicates one or more commands to the set-top device 50 thereby controlling a presentation of the VOD media content.

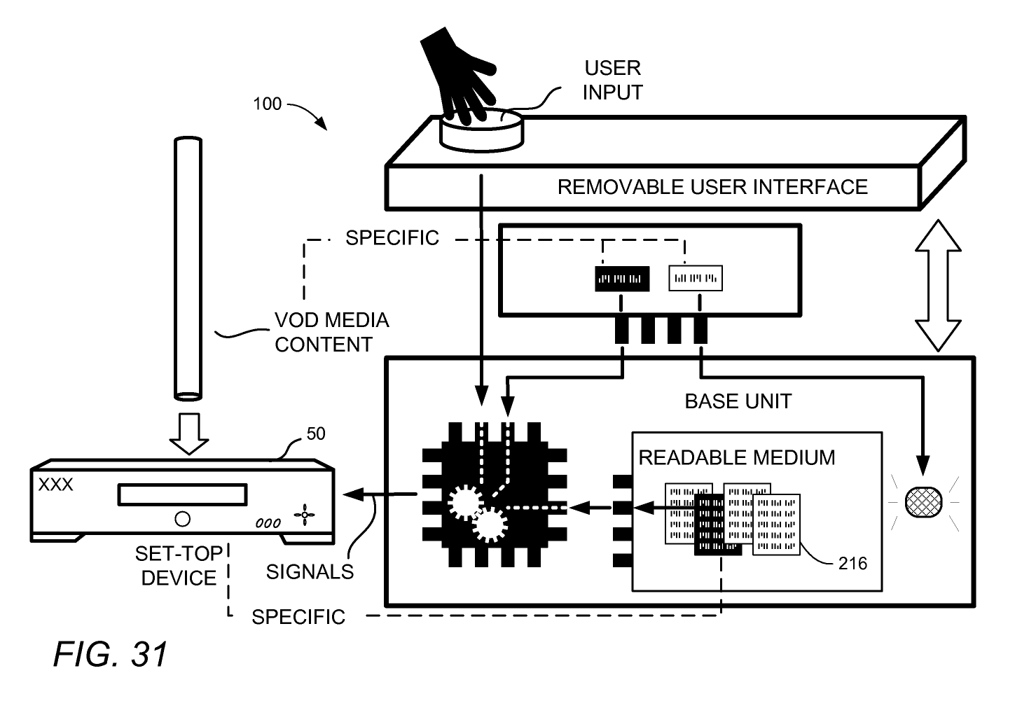

In accordance with yet another aspect of the present invention, FIG. 31 is a schematic diagram of the user premises components of a fifth implementation of an interactive video on demand system 10. In this implementation, additional media content is provided that accompanies and is presented by one or more user premises components of the system 10. The additional media content is shown as included on the CISM with the Device Independent Instructions. The base unit includes a media presentation component for presenting the additional media content. While shown as a speaker component in FIG. 31, it will be apparent that the media presentation component could comprise a visual display screen for presentation of video media content, or both a screen and a speaker for presentation of video and audio media content.

In the illustrated embodiment of FIG. 31, the additional media content is specific to a media event. More particularly, the additional media content comprises audio content specific to and related to the VOD media content to which the Device Independent Instructions are specific. The audio content may, for example, represent prompts and information for guiding a user in navigating the media content. The audio content may include prompts, responses, answers, instructions, questions, scoring, or indications of progress. The audio content is selected and played on the speaker component of the base unit by the base unit processor in accordance with certain Device Independent Instructions that are executed by the processor.

In other embodiments, additional media content is not specific to particular media content. For example, exemplary additional media content that is generic to media content relates to controlling a media presentation device. In this example, a speaker component of the base unit indicates to a user that a command has been issued to prompt the presentation of media content by playing an additional media content audio sample that states “Please wait, your selection will soon begin.”

In yet other embodiments, additional media content relates to media content but is not specific to a particular media content selection. In one such example, a series of educational lessons in math, spelling, and geography are available on a number of different VOD media programs. Each particular VOD media program provides the series hosted by a particular animated character. This provides a child an opportunity to choose a favorite character to promote the child's interest in the lessons. Additional media content is provided for presentation through a base unit in conjunction with the lessons but is generic to the particular animated character hosting the lessons. In this example, the additional media content comprises audio content that is played through the base unit to simulate a teacher interacting with both the child user and the chosen animated character for a simulated classroom experience wherein the animated character is a simulated classmate. The base unit pronounces words in a spelling lesson and the child user and simulated classmate take turns attempting to spell the words. The child engages in a competition with the simulated classmate and learns that occasionally making mistakes is part of the learning experience of any student by seeing that the simulated classmate sometimes provides a wrong answer.

While not shown, each CISM in each of FIGS. 27-30 further could include stored therein the accompanying media content in accordance with this aspect of the present invention. In this regard, the embodiment of FIG. 27 preferably presents this accompanying media content through the GUI display screen of the base unit; the embodiment of FIG. 28 preferably presents this accompanying media content through the GUI display screen of the removable user interface component; the embodiment of FIG. 29 preferably presents this accompanying media content through the GUI display screen of the PUI; and the embodiment of FIG. 30 preferably presents this accompanying media content through a media presentation component (not shown) of the base unit.

Due to the ability of the technology of one or more aspects of the present invention to define navigational rules for media presentations, preferred embodiments of one or more aspects of the present invention may be utilized in conjunction with both existing and well as new media content developed for use specifically for this technology.

For instance, a VOD media program of Disney's “The Little Mermaid,” which existed prior to the present invention, nevertheless can be viewed in accordance with one or more aspects of the present invention. An interactive viewing of the Little Mermaid is accomplished by creating an appropriate script, whereby each of the user inputs on a user interface relates to appropriate corresponding video segments and, with the “push of a button,” a child can access favorite character scenes, character songs, or interface with bonus material. Moreover, using the “Accompanying Media Content” aspect of the present invention extends the interactive viewing experience without altering the existing VOD media program by adding audio and/or visual prompts that play from a media presentation component of the control apparatus.

Due to the ability of the technology of one or more aspects of the present invention to work with existing titles, interactive viewing in accordance with one or more aspects of the present invention across large libraries of existing titles is achieved.

In addition to working with existing VOD media content already resident on, or available to, the video disk arrays 28 or other storage device of the head-end system 20, such existing media content can be combined with newly created media content (“Augmented”) in accordance with one or more aspects of the present invention to further enhance the interactive experience of a user. In this regard, for example, an existing VOD media program can be reproduced to include not only the original media content thereof, but additional media content specifically developed for use with the technology of one or more aspects of the present invention. The additional media content may include, for example, video prompts.

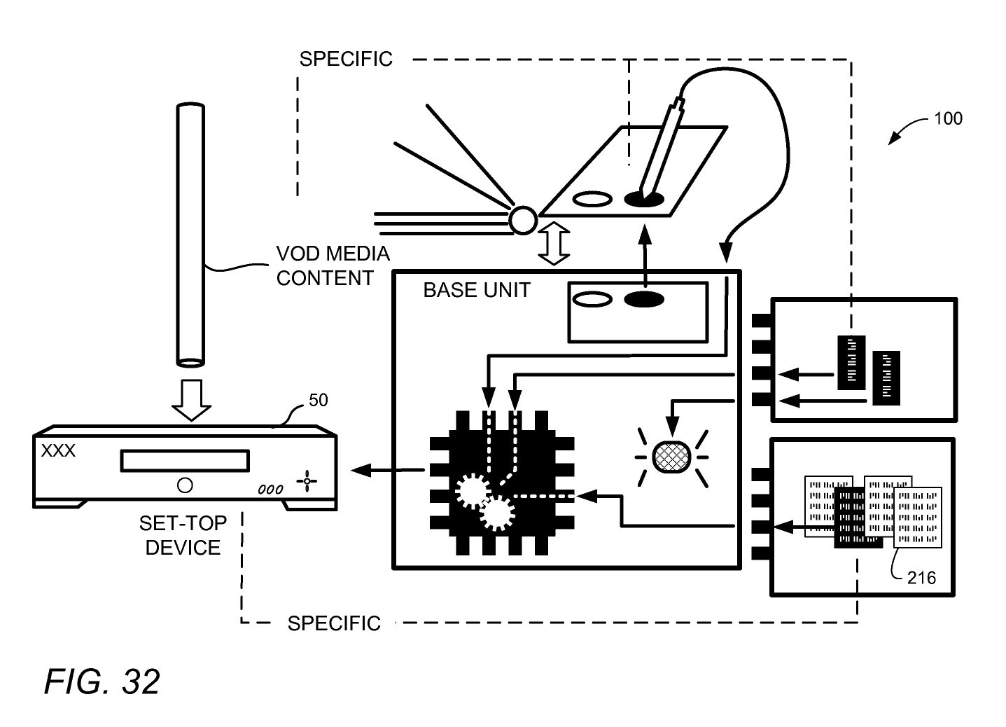

In accordance with yet another aspect of the present invention, FIG. 32 is a schematic diagram of the user premises components of a sixth implementation of an interactive video on demand system 10. In this implementation, a user control device 100 includes a removable user interface component removably disposed on the base unit. The apparatus further includes a first machine readable medium having machine executable instructions related to a VOD media program but not specific to any particular set-top or other device (“Device Independent Instructions”). The first machine readable medium preferably comprises a controller-independent storage medium (CISM) capable of storing computer-executable instructions, and the base unit preferably includes an interface for communicating with the CISM and reading the Device Independent Instructions therefrom. Each user control device 100 further includes a second machine readable medium having a library of selections of software instructions (“Device Dependent Instructions”), each selection being related to a particular set-top device 50 or other host system device and to the particular communication and control protocol thereof. The user control device 100 further includes a user input disposed in communication with the base unit. The base unit includes a processor and a program executed by the processor for communicating by the base unit to the set-top device 50 or other device, in a protocol of that device, media device signals relating to controlling the VOD media program.

The program, vis-à-vis the processor, in response to actuation of a user input, performs the steps of reading and/or interpreting Device Independent Instructions, accessing the Device Dependent Instructions in the library based on the Device Independent Instructions read and/or interpreted, and communicating commands to the set-top device 50 or other device based on the Device Specific Instructions accessed from the library. That is, actuation of the user input prompts the base unit to send a signal, preferably representative of a command, to the set-top device 50 for controlling the presentation of a VOD media program. The signal or command sent depends both on the Device Independent Instructions with regard to the particular media program and on the Device Dependent Instructions with regard to controlling the particular host system device.

In FIG. 32, the user input comprises a stylus disposed in electronic communication with the base unit. The user input is actuated by placement of the stylus proximal an actuation zone of the base unit. The stylus receives a location dependent signal from the base unit when the stylus is placed in close proximity to a location of an actuation zone. The base unit interprets the location dependent signal as a particularly selected actuation of the user input and sends a signal, preferably representative of a command, to the set-top device 50 or other device for controlling the presentation of the media program. Surface position location systems for determining a location of a stylus proximal a surface and interpreting that determination as a user input to prompt the retrieval of stored data pertaining to the determined location are described in U.S. Pat. No. 5,686,705 to Conroy, et al., (the “Conroy patent”) which is hereby incorporated herein by reference, and in U.S. Pat. No. 5,877,458 to Flowers, (the “Flowers patent”) which is hereby incorporated herein by reference.

The removable user interface component of FIG. 32 comprises an overlay for placement over the base unit. The overlay includes graphical indicia which are each related to a particular VOD media program. The graphical indicia visually indicate to a user the locations of actuation zones for guiding the user to selectively actuate the user input by placing the stylus in close proximity to a selected actuation zone. The selective actuation prompts the processor to interpret the Device Independent Instructions, and, utilizing Device Dependent Instructions, communicate a signal, preferably representative of a command, to the set-top device 50. A user thus selectively controls a media presentation by placing the stylus close to a selected graphical indication of the overlay for a convenient and readily understood point and play experience.

The removable user interface component of FIG. 32 further comprises a book having multiple overlay pages bound by, and able to turn about, a coil, rings, binding, or other junction. Each page of the book graphically indicates actuation zones particular to the page and particular to portions of the VOD media content. As a particular page is selected by the user, particular actuation zones are defined according to the Device Independent Instructions of the CISM.

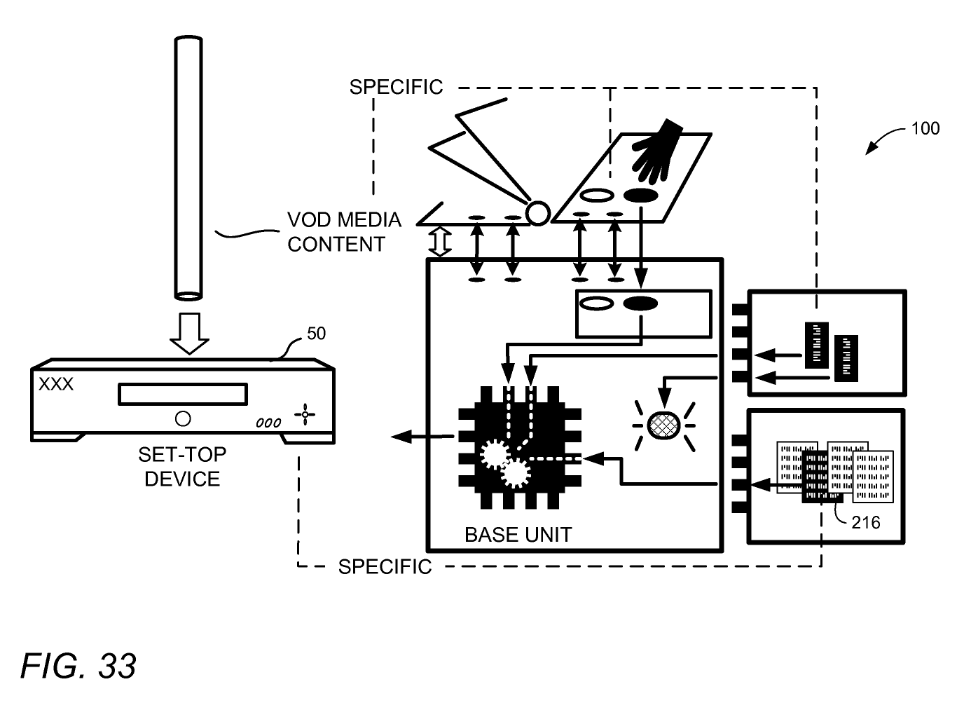

In accordance with yet another aspect of the present invention, FIG. 33 is a schematic diagram of the user premises components of a seventh implementation of an interactive video on demand system 10. This implementation is similar to that of FIG. 32, except that in FIG. 33 the user input comprises a position sensor disposed in electronic communication with the base unit. The user input is actuated by placement of a selector proximal the position sensor. The selector in FIG. 33 is a human appendage such as a portion of a hand or a digit such as a finger, but in other embodiments of the user input, the selector comprises a pointer or stylus, separate from the base unit, that is held and positioned by hand or otherwise placed by a user.

In one embodiment of a user input, a position sensor comprises a plurality of pressure sensitive switches. The pressing of one or more of the switches defines a particular actuation of the user input. In this embodiment, a removable user interface component overlays the user input and has graphical indicia representing individual switches or areas of switches to guide a user in selecting a particular actuation. In this embodiment, pressing of one or more of the switches occurs through the overlaying removable user interface component.

In a preferred embodiment of the user input, the position sensor has an active range of sensitivity. The user input is actuated by a user's placement of a selector within the active range. One or more user input selections are defined within the user input and are each selectable by the position of the placement of the selector. In this embodiment, the removable user interface component overlays the user input and has graphical indicia representing input selections to guide a user in making a particular user input selection favored by the user and represented by a particular graphical indication. The position sensor detects placement of the selector within the active range through the overlaying removable user interface component and generates a signal that is dependent on the location of the detected placement. The base unit interprets the location dependent signal as an actuation of the particular user input selection and sends a signal, preferably representative of a command, to the set-top device 50 for controlling the presentation of a VOD media program. The signal sent depends on the Device Independent Instructions and the selection, with regard to presentation of a particular media program, and depends on particular Device Dependent Instructions, with regard to controlling a particular device of the host system to deliver the presentation.

A position sensor for detecting the presence of a selector within an active range, for determining the location of the selector, and for generating a signal associated with a selection according to the location of the selector is described in U.S. patent application Ser. No. 10/448,583 of Kelley et al. (the “Kelley application”), filed on May 30, 2003, as published under Pub. No. US2004/0043365A1 on Mar. 4, 2004, which patent application is hereby incorporated herein by reference in its entirety.

Though the user input of FIG. 33 is illustrated as a component of the base unit, other embodiments within the scope of the present invention include user inputs that are peripheral to the base unit and are in communication with the base unit via wireless signals or via one or more wires.

In the preferred embodiment illustrated in FIG. 33, the removable user interface component comprises a book of overlays each having graphical indicia representing user input selections. One or more page identification sensors are disposed in electronic communication with the base unit. Furthermore, the book comprises one or more page identifiers sensed by the sensors for determination by the base unit of the particular two-page spread configuration of the book when disposed on the base unit and opened to a pair of opposing pages. Page identifiers and page identification sensors are described in conjunction with a book of overlay pages in the Kelley application.

As illustrated in FIG. 33, additional media content accompanies the Device Independent Instructions of the medium, and the base unit includes a component through which the additional media content is to be presented to accompany media content. While the media presentation component of the base unit of FIG. 33 is shown as a speaker, another exemplary media presentation component comprises a video display screen for presentation of video media content, and yet another comprises both a screen and a speaker for presentation of video and audio additional media content.

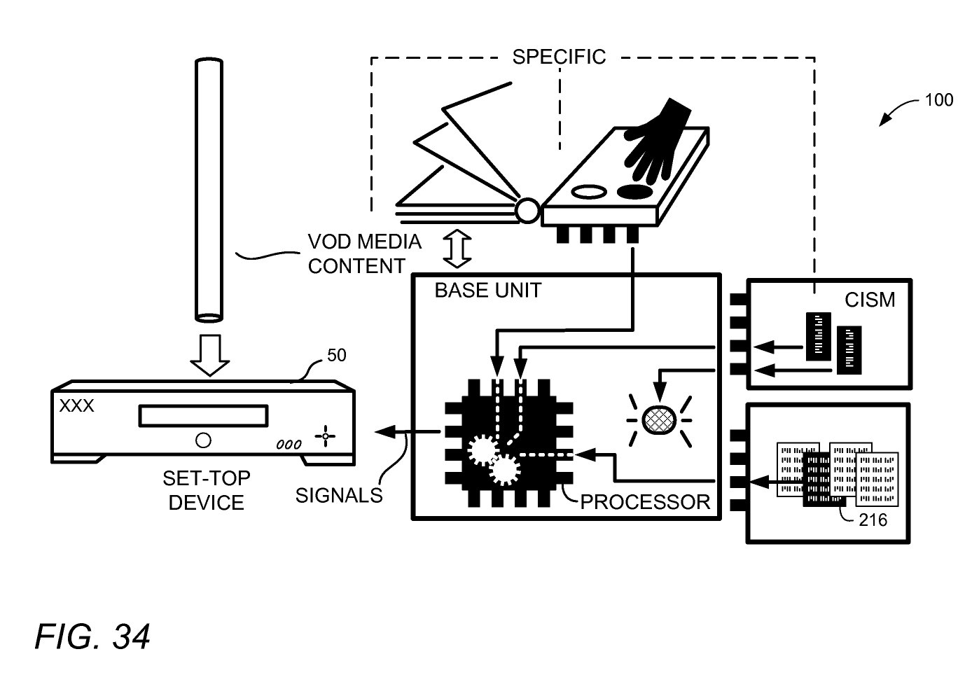

In accordance with yet another aspect of the present invention, FIG. 34 is a schematic diagram of the user premises components of an eighth implementation of an interactive video on demand system 10. In this implementation, the user control device 100 includes a removable user interface component comprising a book of pages and further comprises user inputs graphically represented by indicia on the pages. The removable user interface component in this embodiment has an electrical interface for electronic communication with the base unit. Though the interface is illustrated in FIG. 34 as multiple electrical contacts received by a port of the base unit, any suitable arrangement comprising a wireless transmitter or any number of wires is within the scope of the present invention. Optionally each page comprises user inputs for actuation by a selector. Alternatively, a base page comprises the user inputs and other pages of the book, having graphical indicia, selectively overlay the base page and guide the user in placing the selector to actuate a user input. A removable user interface component comprising a position sensor as described in the Kelley application, a removable user interface component comprising a surface position location system as described in the Conroy patent and in the Flowers patent, and a removable user interface component comprising a plurality of pressure sensitive switches are all within the scope of at least one embodiment of the present invention. Indeed, any suitable arrangement for generating signals according to a selective actuation by a user is within the scope of at least one embodiment of the removable user interface component of the present invention.

What is claimed is:

1. A method performed by a user control device for providing an interactive experience with video on demand (VOD) media content, the method comprising:
(a) receiving, by the user control device, a user-generated signal that is representative of a response of the user to a first video sequence of the VOD media content that is presented to the user;
(b) in response to the user-generated signal received in said step (a), determining, by the user control device, one or more media control signals to communicate to a multimedia control device that will result in the playing of an appropriate video sequence of the VOD media content in order to provide to the user an interactive experience with the VOD media content, the appropriate video sequence being one of a plurality of possible video sequences of the VOD media content that are available for presentation to the user subsequent to the first video sequence; and
(c) wirelessly communicating, by the user control device, for receipt by the multimedia control device, the one or more media control signals determined in said step (b) for playing of the appropriate video sequence;
whereby the appropriate video sequence of the VOD media content is played in reply to the response of the user in said step (a) and the interactive experience with the VOD media content is provided to the user.

2. The method of claim 1, wherein the media control device comprises a digital cable set-top box.

3. The method of claim 1, wherein the user control device comprises a remote control.

4. The method of claim 3, wherein the remote control includes software (i.e., data and/or computer-executable instructions) specific to the video sequences of the VOD media content, the software constituting the logic for navigating the video sequences so as to provide an interactive experience.

5. The method of claim 4, wherein the software comprises a script and wherein the remote control includes a processor and script interpreter for executing the script.

6. The method of claim 5, wherein the scripting language is an XML language.

7. The method of claim 4, wherein the software is provided to the remote control via a removable memory device.

8. The method of claim 7, wherein the removable memory device comprises a cartridge.

9. The method of claim 7, wherein the removable memory device constitutes part of a user interface component that is removably attached to a base of the remote control.

10. The method of claim 4, wherein the software is provided wirelessly to the remote control.

11. The method of claim 1, wherein the user control device comprises a user interface component and a remote control base to which the user interface component is removably coupled.

12. The method of claim 11, wherein the user interface component comprises an overlay.

13. The method of claim 11, wherein the user interface component comprises a card.

14. The method of claim 11, wherein the user interface component comprises an insert.

15. The method of claim 11, wherein the user interface component comprises a touch screen and a graphical user interface (GUI).

16. The method of claim 15, wherein a removable memory device includes software (i.e., data and/or computer-executable instructions) specific to the video sequences of the VOD media content, the software constituting the logic for navigating the video sequences so as to provide an interactive experience, and further includes software defining the GUI.

17. The method of claim 16, wherein the GUI is specific to the video sequences of the VOD media content.

18. The method of claim 11, wherein the user interface component comprises a book.

19. The method of claim 1, wherein the user control device comprises a book.

20. The method of claim 1, wherein the user control device comprises a child's toy.

21. The method of claim 1, wherein the user control device comprises a doll.

22. The method of claim 1, wherein the user control device comprises a child's activity table.

23. The method of claim 1, wherein said step (c) comprises transmitting infrared (Ir) wireless communications.

24. The method of claim 1, wherein said step (c) comprises transmitting radio frequency (RF) wireless communications.

25. A user control device that performs the method of claim 1.

26. A VOD system configured to perform the method of claim 1.

27. A method of interactively viewing, by a child, video on demand (VOD) media content, comprising the steps of:
(a) storing, at a head-end of a VOD system, VOD media content, the VOD media content being organized into at least two child-oriented programs, each program configured to display, on a television, both video content for viewing by a child and menus of selection options for navigating of the program by the child, each menu of the program having at least some selection options displayed using child-recognizable icons;
(b) selecting a user interface component from a plurality of user interface components, each user interface component being specific to a respective one of the child-oriented programs stored at the VOD head-end, and each user interface component including a plurality of child-recognizable icons that are depicted thereon and that correspond visually to icons displayed in the menus of the respective program;
(c) coupling the user interface component to a remote control component having a control chip configured to send wireless control signals, representative of industry standard set-top remote control button presses, to a set-top box for controlling presentation of the VOD media content;
(d) viewing, by the child, the video content of the respective child-oriented program and a menu of selection options of the respective program as displayed using the child-recognizable icons;
(e) choosing, by the child, one of the selection options from the menu of selection options viewed by the child and displayed on the television using the child-recognizable icons;
(f) identifying, by the child, the icon on the coupled user interface component that visually corresponds to the icon, on the menu of selection options, that represents the chosen selection option; and
(g) pressing, by the child, the identified icon of the user interface component to cause the remote control component to send one or more wireless remote control signals, representative of an industry standard set-top remote control button press, to the set-top box indicating to the set-top box the selection option chosen by the child from the viewed menu of displayed selection options.

28. The method of claim 27, wherein the set-top box includes software (i.e., data and/or computer-executable instructions) specific to the video sequences of the VOD media content, the software constituting the logic for navigating the video sequences so as to provide an interactive experience.

29. The method of claim 29, wherein the software is provided to the set-top box via a removable memory card.

30. The method of claim 29, wherein the software comprises a scripting language.

31. The method of claim 29, wherein the software is independent of the brand and model of the set-top box and is independent of the VOD system.

32. The method of claim 29, wherein the software is downloaded to the set-top box.

33. The method of claim 29, wherein the software is downloaded to the set-top box upon selection of one of the two child-oriented programs.

34. The method of claim 33, wherein the software that is downloaded to the set-top box upon selection of a first of the two child-oriented programs is different from the software that is downloaded to the set-top box upon selection of the other of the two child-oriented programs.

35. A method of interactively viewing, by a child, video on demand (VOD) media content, comprising the steps of:
(a) storing, at a head-end of a VOD system, VOD media content, the VOD media content being organized into at least two child-oriented programs, each program configured to display, on a television, both video content for viewing by a child and menus of selection options for navigating of the program by the child, each menu of the program having at least some selection options displayed using child-recognizable icons;
(b) displaying, on a user control device, a graphical user interface from a plurality of graphical user interfaces to the child, each graphical user interface being specific to a respective one of the child-oriented programs stored at the VOD head-end, and each graphical user interface including a plurality of child-recognizable icons that are depicted thereon and that correspond visually to icons displayed in the menus of the respective program, the user control device having a control chip configured to send wireless control signals, representative of industry standard set-top remote control button presses, to a set-top box for controlling presentation of the VOD media content;
(c) viewing, by the child, the video content of the respective child-oriented program and a menu of selection options of the respective program as displayed using the child-recognizable icons;
(d) choosing, by the child, one of the selection options from the menu of selection options viewed by the child and displayed on the television using the child-recognizable icons;
(e) identifying, by the child, the icon on the displayed graphical user interface that visually corresponds to the icon, on the menu of selection options, that represents the chosen selection option; and
(f) pressing, by the child, the identified icon of the graphical user interface to cause the user control device to send one or more wireless remote control signals, representative of an industry standard set-top remote control button press, to the set-top box indicating to the set-top box the selection option chosen by the child from the viewed menu of displayed selection options.
